(19) United States
(12) Patent Application Publication
(10) Pub. No.: US 2024/0180180 A1
(43) Pub. Date: Jun. 6, 2024

(54) COATING COMPOSITIONS INCLUDING LECITHINS OR DERIVATIVES THEREOF

(71) Applicant: Apeel Technology, Inc., Goleta, CA (US)

(72) Inventors: Daniel Essert, Goleta, CA (US); Gigi Lin, Goleta, CA (US)

(21) Appl. No.: 18/517,085

(22) Filed: Nov. 22, 2023

Related U.S. Application Data
(60) Provisional application No. 63/427,758, filed on Nov. 23, 2022.

(51) Int. Cl. A23B 7/16; A23B 7/154; A23L 3/3517; A23L 3/3553

(52) U.S. Cl. CPC A23B 7/16; A23B 7/154; A23L 3/3517; A23L 3/3553

(57) ABSTRACT

The present disclosure relates to compositions including monoglycerides and alkyl esters of fatty acids. An exemplary embodiment includes about 15 wt % to about 99 wt % of one or more monoglycerides of a C₄-C₂₈ fatty acid, and about 1 wt % to about 75 wt % of one or more alkyl esters of a C₈-C₂₀ fatty acid.

### CROSS-REFERENCE TO RELATED APPLICATION

This application claims the benefit of priority to U.S. Application No. 63/427,758, filed on Nov. 23, 2022, which is incorporated by reference herein its entirety.

### TECHNICAL FIELD

The present disclosure relates to coatings for agricultural products.

### BACKGROUND

Common agricultural products are susceptible to degradation and decomposition (i.e., spoilage) when exposed to the environment. Such agricultural products can include, for example, eggs, fruits, vegetables, produce, seeds, nuts, flowers, and/or whole plants (including their processed and semi-processed forms). Non-agricultural products (e.g., vitamins, candy, etc.) are also vulnerable to degradation when exposed to the ambient environment. The degradation of the agricultural products can occur via abiotic means as a result of evaporative moisture loss from an external surface of the agricultural products to the atmosphere, and/or oxidation by oxygen that diffuses into the agricultural products from the environment, and/or mechanical damage to the surface, and/or light-induced degradation (i.e., photodegradation). Furthermore, biotic stressors such as, for example, bacteria, fungi, viruses, and/or pests can also infest and decompose the agricultural products.

Conventional approaches to preventing degradation, maintaining quality, and increasing the life of agricultural products include refrigeration and/or special packaging. Refrigeration requires capital-intensive equipment, demands constant energy expenditure, can cause damage or quality loss to the product if not carefully controlled, and must be actively managed. Also, the benefits of refrigeration can be lost upon interruption of a temperature-controlled supply chain. Special packaging can also require expensive equipment, consume packaging material, increase transportation costs, and require active management. Despite the benefits that can be afforded by refrigeration and special packaging, the handling and transportation of the agricultural products can cause surface abrasion or bruising that is aesthetically displeasing to the consumer and can serve as a point of ingress for bacteria and fungi. Moreover, the expenses associated with such approaches can add to the cost of the agricultural product.

### SUMMARY

Provided herein is a composition including one or more monoglycerides of a C₄-C₂₈ fatty acid, present in a total amount of about 10 wt % to about 90 wt % of the composition, and a lecithin, present in an amount of about 10 wt % to about 90 wt % of the composition.

Also provided herein is a composition including one or more monoglycerides of a C₄-C₂₈ fatty acid, and a lecithin, wherein a ratio of a total mass of the one or more monoglycerides to a total mass of the lecithin is about 10:1 to about 1:10.

Also provided herein is a composition including one or more monoglycerides of a C₄-C₂₈ fatty acid; one or more alkyl esters of a C₄-C₂₈ fatty acid, and a lecithin. A ratio of a total mass of the one or more monoglycerides to a total mass of the one or more alkyl esters is about 20:1 to about 1:1, and a ratio of a total mass of the one or more monoglycerides and the one or more alkyl esters to a total mass of the lecithin is about 10:1 to about 1:10.

Also provided herein is a composition including one or more monoglycerides of a C₄-C₂₈ fatty acid, present in a total amount of about 10 wt % to about 90 wt % of the composition, and one or more glycerophospholipids, present in an amount of about 4 wt % to about 40 wt % of the composition.

Also provided herein is a mixture of a composition described herein and a solvent.

Also provided herein is a coated agricultural product including an agricultural product and a layer disposed on a surface of the agricultural product, the layer including a composition described herein.

Also provided herein is a method of coating an agricultural product, the method including contacting a surface of the agricultural product with a mixture including a coating agent and a solvent, and removing at least a portion of the solvent to form a coating on the surface of the agricultural product. The coating agent includes one or more monoglycerides of a C₄-C₂₈ fatty acid, and a lecithin. A ratio of a total mass of the one or more monoglycerides to a total mass of the lecithin is about 10:1 to about 1:10.

Also provided herein is a method of coating an agricultural product, the method including contacting a surface of the agricultural product with a mixture described herein, and removing at least a portion of the solvent to form a coating on the surface of the agricultural product.

Although the disclosed inventive concepts include those defined in the attached claims, it should be understood that the inventive concepts can also be defined in accordance with the following embodiments.

Embodiment 1 is a composition comprising:
one or more monoglycerides of a C₄-C₂₈ fatty acid, present in a total amount of about 10 wt % to about 90 wt % of the composition; and
a lecithin, present in an amount of about 10 wt % to about 90 wt % of the composition.

Embodiment 2 is the composition of embodiment 1, wherein:
the one or more monoglycerides are present in a total amount of about 10 wt % to about 50 wt % of the composition;
the lecithin is present in an amount of about 50 wt % to about 90 wt % of the composition.

Embodiment 3 is the composition of embodiment 1, wherein:
the one or more monoglycerides are present in a total amount of about 50 wt % to about 90 wt % of the composition; and
the lecithin is present in an amount of about 10 wt % to about 50 wt % of the composition.

Embodiment 4 is the composition of embodiment 3, wherein:
the one or more monoglycerides are present in a total amount of about 50 wt % to about 65 wt % of the composition; and
the lecithin is present in an amount of about 35 wt % to about 50 wt % of the composition.

Embodiment 5 is the composition of embodiment 3, wherein:
the one or more monoglycerides are present in an amount of about 65 wt % to about 80 wt % of the composition; and
the lecithin is present in an amount of about 20 wt % to about 35 wt % of the composition.

Embodiment 6 is the composition of embodiment 3, wherein:
the one or more monoglycerides are present in an amount of about 80 wt % to about 90 wt % of the composition; and
the lecithin is present in an amount of about 10 wt % to about 20 wt % of the composition.

Embodiment 7 is the composition of any of embodiments 1-6, wherein the one or more monoglycerides comprise:
one or more monoglycerides of a C₁₆-C₂₈ fatty acid; and
one or more monoglycerides of a C₄-C₁₄ fatty acid.

Embodiment 8 is the composition of embodiment 7, wherein the one or more monoglycerides of a C₄-C₁₄ fatty acid are present in a total amount of about 1 wt % to about 15 wt % of the composition.

Embodiment 9 is a composition comprising:
one or more monoglycerides of a C₄-C₂₈ fatty acid; and
a lecithin,
   wherein a ratio of a total mass of the one or more monoglycerides to a total mass of the lecithin is about 10:1 to about 1:10.

Embodiment 10 is the composition of embodiment 9, wherein the ratio of the total mass of the one or more monoglycerides to the total mass of the lecithin is about 1:1 to about 1:9.

Embodiment 11 is the composition of embodiment 9, wherein the ratio of the total mass of the one or more monoglycerides to the total mass of the lecithin is about 9:1 to about 1:1.

Embodiment 12 is the composition of embodiment 11, wherein the ratio of the total mass of the one or more monoglycerides to the total mass of the lecithin is about 2:1 to about 1:1.

Embodiment 13 is the composition of embodiment 11, wherein the ratio of the total mass of the one or more monoglycerides to the total mass of the lecithin is about 4:1 to about 2:1.

Embodiment 14 is the composition of embodiment 11, wherein the ratio of the total mass of the one or more monoglycerides to the total mass of the lecithin is about 9:1 to about 4:1.

Embodiment 15 is the composition of any of embodiments 9-14, wherein the one or more monoglycerides comprise:
one or more monoglycerides of a C₁₆-C₂₈ fatty acid; and
one or more monoglycerides of a C₄-C₁₄ fatty acid.

Embodiment 16 is the composition of any of embodiments 9-15, wherein the one or more monoglycerides and the lecithin are present in an amount of at least about 80 wt % of the composition.

Embodiment 17 is a composition comprising:
one or more monoglycerides of a C4-C28 fatty acid;
one or more alkyl esters of a C4-C28 fatty acid; and
a lecithin;
   wherein
a ratio of a total mass of the one or more monoglycerides to a total mass of the one or more alkyl esters is about 20:1 to about 1:1; and
a ratio of a total mass of the one or more monoglycerides and the one or more alkyl esters to a total mass of the lecithin is about 10:1 to about 1:10.

Embodiment 18 is the composition of embodiment 17, wherein:
the one or more monoglycerides and the one or more alkyl esters are present in a total amount of about 10 wt % to about 50 wt % of the composition;
the lecithin is present in an amount of about 50 wt % to about 90 wt % of the composition.

Embodiment 19 is the composition of embodiment 17, wherein:
the one or more monoglycerides and the one or more alkyl esters are present in a total amount of about 50 wt % to about 90 wt % of the composition, and
the lecithin is present in an amount of about 10 wt % to about 50 wt % of the composition.

Embodiment 20 is the composition of any of embodiments 17-19, wherein the one or more monoglycerides, the one or more alkyl esters, and the lecithin are present in an amount of at least about 80 wt % of the composition.

Embodiment 21 is the composition of any of embodiments 17-20, wherein the ratio of the total mass of the one or more monoglycerides to the total mass of the one or more alkyl esters is about 10:1 to about 2:1.

Embodiment 22 is the composition of any of embodiments 1-21, wherein the lecithin comprises a hydrolyzed lecithin.

Embodiment 23 is the composition of any of embodiments 1-22, wherein the lecithin comprises a soybean lecithin, a sunflower lecithin, or a rapeseed lecithin.

Embodiment 24 is the composition of any of embodiments 1-23, wherein the lecithin comprises one or more glycerophospholipids.

Embodiment 25 is the composition of embodiment 24, wherein the one or more glycerophospholipids are present in an amount of about 20 wt % to about 60 wt % of the lecithin.

Embodiment 26 is the composition of any of embodiments 1-25, wherein the lecithin comprises one or more triglycerides.

Embodiment 27 is the composition of embodiment 26, wherein the one or more triglycerides are present in an amount of about 5 wt % to about 50 wt % of the lecithin.

Embodiment 28 is a composition comprising:
one or more monoglycerides of a C₄-C₂₈ fatty acid, present in a total amount of about 10 wt % to about 90 wt % of the composition; and
one or more glycerophospholipids, present in an amount of about 4 wt % to about 40 wt % of the composition.

Embodiment 29 is the composition of embodiment 28, wherein
the one or more monoglycerides are present in a total amount of about 50 wt % to about 90 wt % of the composition; and
the one or more glycerophospholipids are present in a total amount of about 4 wt % to about 25 wt % of the composition.

Embodiment 30 is the composition of embodiment 28 or embodiment 29, wherein the one or more monoglycerides comprise:
one or more monoglycerides of a C₁₆-C₂₈ fatty acid; and
one or more monoglycerides of a C₄-C₁₄ fatty acid.

Embodiment 31 is the composition of embodiment 30, wherein the one or more monoglycerides of a C₄-C₁₄ fatty acid are present in a total amount of about 1 wt % to about 15 wt % of the composition.

Embodiment 32 is the composition of any of embodiments 28-31, further comprising one or more triglycerides.

Embodiment 33 is the composition of embodiment 32, wherein the one or more triglycerides are present in a total amount of about 3 wt % to about 35 wt % of the composition.

Embodiment 34 is the composition of embodiment 32, wherein the one or more triglycerides are present in a total amount of about 3 wt % to about 20 wt % of the composition.

Embodiment 35 is the composition of any of embodiments 24-34, wherein the one or more glycerophospholipids comprise a phosphatidylcholine, a lysophosphatidylcholine, a phosphatidylethanolamine, a lysophosphatidylethanolamine, a phosphatidylinositol, a lysophosphatidylinositol, a phosphatidylserine, a lysophosphatidylserine, a phosphatidic acid, a lysophosphatidic acid, or any combination thereof.

Embodiment 36 is the composition of embodiment 35, wherein the one or more glycerophospholipids comprise a phosphatidylcholine, a phosphatidylethanolamine, a phosphatidylinositol, and a phosphatidic acid.

Embodiment 37 is the composition of embodiment 35 or embodiment 36, wherein the one or more glycerophospholipids comprise a phosphatidylserine.

Embodiment 38 is the composition of any of embodiments 24-37, wherein one or more of the glycerophospholipids independently comprises one or more C₈-C₂₂ side chains.

Embodiment 39 is the composition of any of embodiments 26, 27, and 32-38, wherein one or more of the triglycerides independently comprises one or more C₈-C₂₂ side chains.

Embodiment 40 is the composition of any of embodiments 24-39, wherein one or more of the glycerophospholipids independently comprises a compound of Formula III:

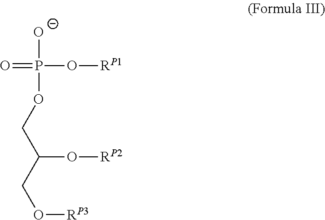

wherein:
each R^{P1} is independently —H,

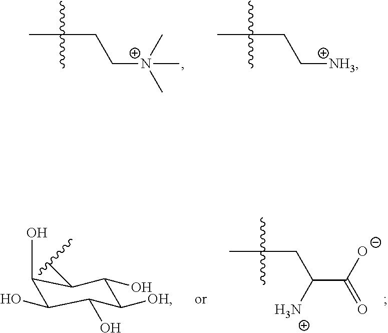

each R^{P2} and R^{P3} is independently —H or —C(O)R^{H};
at least one of R^{P2} and R^{P3} is not —H; and
each R^{H} is independently a C₇-C₂₁ side chain.

Embodiment 41 is the composition of any of embodiments 26, 27, and 32-40, wherein one or more of the triglycerides independently comprises a compound of Formula IV:

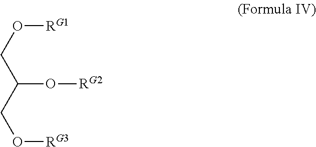

wherein:
each R^{G1}, R^{G2}, and R^{G3} is independently —C(O)R^{H}; and
each R^{H} is independently a C₇-C₂₁ side chain.

Embodiment 42 is the composition of embodiment 40 or embodiment 41, wherein each R^{H} is independently a C₁₅ or C₁₇ side chain.

Embodiment 43 is the composition of any of embodiments 40-42, wherein each R^{H} is an unsubstituted side chain.

Embodiment 44 is the composition of any of embodiments 40-43, wherein each R^{H} is independently a saturated side chain, a mono-unsaturated side chain, a di-unsaturated side chain, or a tri-unsaturated side chain.

Embodiment 45 is the composition of any of embodiments 1-44, wherein each of the one or more monoglycerides independently comprises a compound of Formula I-i or Formula I-ii:

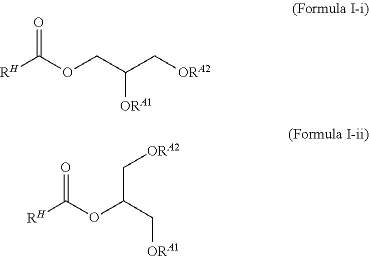

wherein:
R^{A1} and R^{A2} are each independently selected from H and C₁-C₆ alkyl; and
R^{H} is a C₃-C₂₇ side chain.

Embodiment 46 is the composition of embodiment 45, wherein R^{A1} and R^{A2} are each H.

Embodiment 47 is the composition of embodiment 45 or embodiment 46, wherein R^{H} is a saturated, unsubstituted side chain.

Embodiment 48 is the composition of any of embodiments 45-47, wherein R^{H} is a C₁₁-C₂₁ side chain.

Embodiment 49 is the composition of any of embodiments 45-48, wherein the one or more monoglycerides comprise:
a first compound of Formula I-i or Formula I-ii, wherein R^{H} is a C₁₅-C₂₇ side chain; and
a second compound of Formula I-i or Formula I-ii, wherein R^{H} is a C₃-C₁₃ side chain.

Embodiment 50 is the composition of any of embodiments 1-44, wherein each of the one or more monoglycerides independently comprises a compound of Formula IA-i or Formula IA-ii:

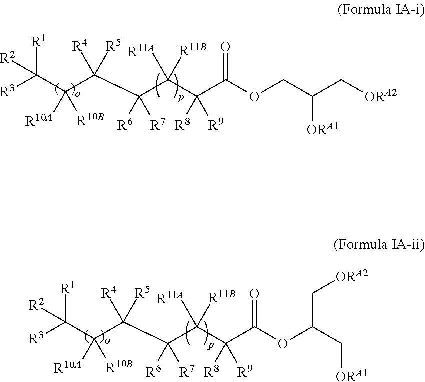

wherein:
R^{A1} and R^{A2} are each independently selected from H and C₁-C₆ alkyl;

R¹, R², R³, R⁴, R⁵, R⁶, R⁷, R⁸, and R⁹ are each independently selected from H, OH, C₁-C₆ alkyl, C₂-C₆ alkenyl, and C₁-C₆ alkoxy;
each occurrence of R^{10A}, R^{10B}, R^{11A}, and R^{11B} is independently selected from H, OH, C₁-C₆ alkyl, C₂-C₆ alkenyl, and C₁-C₆ alkoxy;
any two of R¹, R², R³, R⁴, R⁵, R⁶, R⁷, R⁸, R⁹, R^{10A}, R^{10B}, R^{11A}, and R^{11B} on adjacent carbon atoms can be taken together with the carbon atoms to which they are attached to form a double bond, a 3- to 6-membered ring heterocycloalkyl, or a C₃-C₆ cycloalkyl;
o is an integer from 0 to 17;
p is an integer from 0 to 17; and
the sum of o and p is from 0 to 17.

Embodiment 51 is the composition of embodiment 50, wherein R^{A1} and R^{A2} are each H.

Embodiment 52 is the composition of any of embodiments 17-51, wherein the one or more alkyl esters each independently comprises a C₁-C₅ alkyl ester.

Embodiment 53 is the composition of any of embodiments 17-51, wherein the one or more alkyl esters each independently comprises a methyl ester, an ethyl ester, a propyl ester, an isopropyl ester, a tert-butyl ester, or an iso-amyl ester.

Embodiment 54 is the composition of any of embodiments 17-53, wherein at least one of the alkyl esters comprises an ethyl ester or a propyl ester.

Embodiment 55 is the composition of any of embodiments 17-51, wherein each of the one or more alkyl esters independently comprises a compound of Formula V:

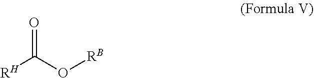

wherein:
R_{B} is C₁-C₈ alkyl; and
R^{H} is a C₇-C₁₉ side chain.

Embodiment 56 is the composition of embodiment 55, wherein R^{B} is C₁-C₅ alkyl. Embodiment 57 is the composition of embodiment 55, wherein R^{B} is C₂ alkyl or C₃ alkyl.

Embodiment 58 is the composition of any of embodiments 55-57, wherein R^{H} is a saturated, unsubstituted side chain.

Embodiment 59 is the composition of any of embodiments 55-58, wherein R^{H} is a C₁₁-C₁₇ side chain.

Embodiment 60 is a mixture comprising:
the composition of any of embodiments 1-59; and
a solvent.

Embodiment 61 is the mixture of embodiment 60, wherein the mixture comprises about 30 wt % to about 99.9 wt % of the solvent.

Embodiment 62 is the mixture of embodiment 60, wherein the mixture comprises about 90 wt % to about 99.5 wt % of the solvent.

Embodiment 63 is the mixture of any of embodiments 60-62, wherein the solvent comprises one or more of water, methanol, ethanol, isopropanol, butanol, acetone, ethyl acetate, chloroform, acetonitrile, tetrahydrofuran, diethyl ether, and methyl tert-butyl ether.

Embodiment 64 is a coated agricultural product comprising an agricultural product and a layer disposed on a surface of the agricultural product, wherein the layer comprises the composition of any of embodiments 1-59.

Embodiment 65 is the coated agricultural product of embodiment 64, wherein the layer is disposed on a cuticular surface of the agricultural product.

Embodiment 66 is the coated agricultural product of embodiment 64 or embodiment 65, wherein a thickness of the layer is about 0.1 μm to about 20 μm.

Embodiment 67 is the coated agricultural product of embodiment 64 or embodiment 65, wherein a thickness of the layer is about 0.1 μm to about 10 μm.

Embodiment 68 is a method of coating an agricultural product, the method comprising:
contacting a surface of the agricultural product with a mixture comprising a coating agent and a solvent, wherein the coating agent comprises:
   one or more monoglycerides of a C₄-C₂₈ fatty acid; and
   a lecithin,
wherein a ratio of a total mass of the one or more monoglycerides to a total mass of
the lecithin is about 10:1 to about 1:10; and
removing at least a portion of the solvent to form a coating on the surface of the agricultural product.

Embodiment 69 is the method of embodiment 68, wherein the one or more monoglycerides comprise:
one or more monoglycerides of a C₁₆-C₂₈ fatty acid; and
one or more monoglycerides of a C₄-C₁₄ fatty acid.

Embodiment 70 is the method of embodiment 68 or embodiment 69, wherein the one or more monoglycerides and the lecithin are present in an amount of at least about 80 wt % of the coating agent.

Embodiment 71 is the method of any of embodiments 68-70, wherein a concentration of the coating agent in the mixture is about 1 mg/mL to about 200 mg/mL.

Embodiment 72 is the method of any of embodiments 68-70, wherein a concentration of the coating agent in the mixture is about 25 mg/mL to about 150 mg/mL.

Embodiment 73 is the method of any of embodiments 68-72, wherein the solvent comprises one or more of water, methanol, ethanol, isopropanol, butanol, acetone, ethyl acetate, chloroform, acetonitrile, tetrahydrofuran, diethyl ether, and methyl tert-butyl ether.

Embodiment 74 is the method of any of embodiments 68-73, wherein the coating agent and the solvent are present in an amount of at least about 98 wt % of the mixture.

Embodiment 75 is the method of any of embodiments 68-74, wherein the surface is a cuticular surface of the agricultural product.

Embodiment 76 is the method of any of embodiments 68-75, wherein contacting the surface comprises:
spraying the mixture onto the surface; or
immersing the agricultural product in the mixture.

Embodiment 77 is the method of any of embodiments 68-76, wherein removing at least a portion of the solvent comprises evaporating at least a portion of the solvent at a temperature of less than 40° C.

Embodiment 78 is the method of any of embodiments 68-76, wherein removing at least a portion of the solvent comprises evaporating at least a portion of the solvent at a temperature of less than 30° C.

Embodiment 79 is the method of any of embodiments 68-76, wherein removing at least a portion of the solvent comprises evaporating at least a portion of solvent solvent at a temperature of 10° C. to 30° C.

Embodiment 80 is the method of any of embodiments 68-79, further comprising combining the coating agent and the solvent to form the mixture.

Embodiment 81 is a method of coating an agricultural product, the method comprising:
contacting a surface of the agricultural product with the mixture of any of embodiments 60-63; and
removing at least a portion of the solvent to form a coating on the surface of the agricultural product.

The details of one or more embodiments of the subject matter of this disclosure are set forth in the accompanying drawings and the description. Other features, aspects, and advantages of the subject matter will become apparent from the description, the drawings, and the claims.

### BRIEF DESCRIPTION OF DRAWINGS

FIG. 1 is a plot of differential scanning calorimetry (DSC) curves for certain mixtures described herein.

FIG. 2 is a plot of DSC curves for certain mixtures described herein.

FIG. 3 is a plot of predicted mass loss factor vs. crystallization enthalpy for certain coating mixtures described herein.

FIG. 4 shows the initial design space for a space-filling mixture design of experiment (DoE) for certain formulations described herein.

FIG. 5 is a result profile for mixibility from a space-filing mixture DoE described herein.

FIG. 6 is a result profile for stability from a space-filing mixture DoE described herein.

FIG. 7 shows the initial design space for a space-filling mixture design of experiment (DoE) for certain formulations described herein.

FIGS. 8A-8D show images of coated cherries having a residue score of 0, 0.5, 1, and 2, respectively, as determined for a space-filling mixture DoE described herein.

FIG. 9 is a ternary plot of mass loss factor results for a space-filling mixture DoE described herein.

FIG. 10 is a ternary plot of residue score results for a space-filling mixture DoE described herein.

FIGS. 11A-11C show images of cherries coated with certain coating agents described herein.

FIGS. 12A-12C show images of bananas coated with certain coating agents described herein. Delamination is indicated with arrows.

FIGS. 13A and 13B show images of bananas coated with certain coating agents described herein.

FIG. 14 is a set of plots showing viscosity data collected from certain mixtures described herein.

FIGS. 15A and 15B show images of cherry tomatoes coated with certain coating agents described herein.

FIGS. 16A-16F show images of uncoated cherry tomatoes and cherry tomatoes coated with certain coating agents described herein.

### DETAILED DESCRIPTION

The present disclosure relates to compositions including monoglycerides and a lecithin. In some embodiments, the compositions further include an alkyl ester. In particular, the compositions described herein can be coated onto an agricultural product and dried at ambient temperature to provide an effective barrier, e.g., to gas or water, having improved aesthetic properties, e.g., reduced visible residue.

Reference will now be made in detail to certain embodiments of the disclosed subject matter. While the disclosed subject matter will be described in conjunction with the enumerated claims, it will be understood that the exemplified subject matter is not intended to limit the claims to the disclosed subject matter.

### Definitions

The terms “a,” “an,” and “the” are used herein to include one or more than one unless the context clearly dictates otherwise. The term “or” is used to refer to a nonexclusive “or” unless otherwise indicated. The statement “at least one of A and B” has the same meaning as “A, B, or A and B.” In addition, it is to be understood that the phraseology or terminology employed in this disclosure, and not otherwise defined, is for the purpose of description only and not of limitation. Any use of section headings is intended to aid reading of the document and is not to be interpreted as limiting; information that is relevant to a section heading may occur within or outside of that particular section.

Values expressed in a range format should be interpreted in a flexible manner to include not only the numerical values explicitly recited as the limits of the range, but also to include all the individual numerical values or sub-ranges encompassed within that range as if each numerical value and sub-range is explicitly recited. For example, a range of “about 0.1% to about 5%” or “about 0.1% to 5%” should be interpreted to include not just about 0.1% to about 5%, but also the individual values (for example, 1%, 2%, 3%, and 4%) and the sub-ranges (for example, 0.1% to 0.5%, 1.1% to 2.2%, 3.3% to 4.4%) within the indicated range. The statement “about X to Y” has the same meaning as “about X to about Y,” unless indicated otherwise. Likewise, the statement “about X, Y, or about Z” has the same meaning as “about X, about Y, or about Z,” unless indicated otherwise.

As used herein, the term “about” allows for a degree of variability in a value or range within 10% of a stated value or of a stated limit of a range.

In the methods described herein, the acts can be carried out in any order, except when a temporal or operational sequence is explicitly recited. Furthermore, specified acts can be carried out concurrently unless explicit claim language recites that they be carried out separately. For example, a claimed act of doing X and a claimed act of doing Y can be conducted simultaneously within a single operation, and the resulting process will fall within the literal scope of the claimed process.

As used herein, the term “monoglyceride” refers to the condensation product of one glycerol molecule and one fatty acid—that is, a glycerol group attached through an ester linkage to one fatty acid. Monoglycerides can, but need not necessarily be derived from a condensation reaction. For example, monoglycerides can be obtained by an esterification reaction between glycerol and a fatty acid, by transesterification of a triglyceride with glycerol (glycerolysis), etc. Monoglycerides can also be referred to as glyceryl monoalkanoates. Where the glycerol group is attached to the ester linkage at the 1-position (e.g., as in 2,3-dihydroxypropan-1-yl octadecanoate), the monoglyceride can be referred to as a 1-monoglyceride or a 1-glyceryl alkanoate (e.g., as in 1-glyceryl octadecanoate). Where the glycerol group is attached to the ester linkage at the 2-position (e.g., as in 1,3-dihydroxypropan-2-yl hexadecanoate), the monoglyceride can be referred to as a 2-monoglyceride or a 2-glyceryl alkanoate (e.g., as in 2-glyceryl hexadecanoate). The glycerol group of a monoglyceride can be unsubstituted (e.g., as in a 2,3-dihyrdroxpropan-1-yl alkanoate), or can be further substituted with one or more groups other than a fatty acid (e.g., as in a 1,3-dialkoxypropan-2-yl alkanoate).

The term “alkyl ester,” used in reference to a fatty acid, refers to the condensation product of an alkanol and a fatty acid-that is, an alkyl group attached through an ester linkage to one fatty acid. Alkyl esters can, but need not necessarily be derived from a condensation reaction. For example, alkyl esters can be obtained by an esterification reaction between an alkanol and a fatty acid, by transesterification of a monoglyceride, triglyceride, etc. Alkyl esters can also be referred to as alkyl alkanoates. For example, an ethyl ester of hexadecanoic acid can also be referred to as ethyl hexadecanoate.

As used herein, the term “fatty acid” refers to carboxylic acids having an aliphatic side chain. Fatty acids can be naturally or non-naturally occurring, and can include a side chain that is branched or unbranched (e.g., linear), substituted or unsubstituted, and saturated or unsaturated.

As used herein, the term “side chain” refers to the aliphatic portion of a fatty acid, or a portion thereof. Unless otherwise indicated, the side chain of a given fatty acid includes the carbon of the carboxylic acid group. For example, dodecanoic acid can be described as including a linear, saturated C₁₂ side chain, and can also be represented as R^{H}—C(O)OH, where R^{H} is a linear, saturated C₁₁ side chain. Side chains can be present in compounds other than fatty acids, such as, for example, esters or amides, and can, but need not necessarily be derived from a fatty acid. For example, dodecanamide can be described as an amide of a fatty acid, whether or not the compound was in fact derived from dodecanoic acid.

Where certain features of the compounds described herein are disclosed in groups or in ranges, such disclosure includes each and every individual sub-combination of the members of such groups and ranges. For example, the term “C₁-C₆ alkyl” includes (without limitation) methyl, ethyl, C₃ alkyl, C₄ alkyl, C₅ alkyl, and C₆ alkyl.

As used herein, the term “n-membered,” where n is an integer, typically describes the number of ring-forming atoms in a moiety where the number of ring-forming atoms is n. For example, piperidinyl is an example of a 6-membered heterocycloalkyl ring, and 1,2,3,4-tetrahydro-naphthalene is an example of a 10-membered cycloalkyl group.

As used herein, the term “substituted” means that an atom or group of atoms formally replaces hydrogen as a “substituent” attached to another group. “Substituted,” unless otherwise indicated, refers to any level of substitution, e.g., mono-, di-, tri-, tetra- or penta-substitution, where such substitution is permitted. The substituents are independently selected, and substitution may be at any chemically accessible position. Substitution at a given atom is limited by valency. Substitution at a given atom results in a chemically stable molecule. The phrase “optionally substituted” means unsubstituted or substituted. A single divalent substituent, e.g., oxo, can replace two hydrogen atoms.

As used herein, the term “Cₙ-Cₘ” indicates a range which includes the endpoints, wherein n and m are integers and indicate the number of carbons. Examples include C₁-C₄, C₁-C₆ and the like.

As used herein, the term “alkyl” refers to a saturated hydrocarbon group that may be straight-chained or branched. The term “Cₙ-Cₘ alkyl” refers to an alkyl group having n to m carbon atoms. An alkyl group formally corresponds to an alkane with one C—H bond replaced by the point of attachment of the alkyl group to the remainder of the compound. Examples of alkyl moieties include, but are not limited to, chemical groups such as methyl, ethyl, n-propyl, isopropyl, n-butyl, tert-butyl, isobutyl, sec-butyl; higher homologs such as 2-methyl-1-butyl, n-pentyl, 3-pentyl, n-hexyl, 1,2,2-trimethylpropyl, and the like.

As used herein, the term “alkenyl” refers to a straight-chain or branched hydrocarbon group corresponding to an alkyl group having one or more double carbon-carbon bonds. An alkenyl group formally corresponds to an alkene with one C—H bond replaced by the point of attachment of the alkenyl group to the remainder of the compound. The term “Cₙ-Cₘ alkenyl” refers to an alkenyl group having n to m carbons. Example alkenyl groups include, but are not limited to, ethenyl, n-propenyl, isopropenyl, n-butenyl, sec-butenyl and the like.

As used herein, the term “alkoxy” refers to a group of formula -O-alkyl, wherein the alkyl group is as defined above. The term “Cₙ-Cₘ alkoxy” refers to an alkoxy group, the alkyl group of which has n to m carbons. Example alkoxy groups include methoxy, ethoxy, propoxy (e.g., n-propoxy and isopropoxy), t-butoxy and the like.

As used herein, the term “cycloalkyl” refers to a non-aromatic hydrocarbon ring system (monocyclic, bicyclic, or polycyclic), including cyclized alkyl and alkenyl groups. The term “Cₙ-Cₘ cycloalkyl” refers to a cycloalkyl that has n to m ring member carbon atoms. Cycloalkyl groups can include fused, bridged, and/or spiro bicyclic or polycyclic ring systems. Examples of cycloalkyl groups include, but are not limited to, cyclopropyl, cyclobutyl, cyclopentyl, cyclohexyl, cycloheptyl, cyclopentenyl, cyclohexenyl, cyclohexadienyl, cycloheptatrienyl, norbornyl, norpinyl, norcarnyl, bicyclo[1.1.0]butanyl, bicyclo[1.1.1]pentanyl, bicyclo[2.1.0]pentanyl, bicyclo[2.2.0]hexanyl, bicyclo[3.1.0]hexanyl, bicyclo[3.2.0]heptanyl, and bicyclo[3.3.0]-octanyl, bicyclo[2.1.1]hexanyl, bicyclo[2.2.1]heptanyl and bicyclo[1.1.1 ]pentanyl, and the like.

As used herein, the term “heterocycloalkyl” refers to a non-aromatic ring system (monocyclic, bicyclic, or polycyclic), which may optionally contain one or more alkenylene groups as part of the ring structure, which has at least one heteroatom ring member independently selected from nitrogen, sulfur, oxygen, and phosphorus. The term “n- to m-membered ring heterocycloalkyl” refers to a heterocycloalkyl that has n to m ring-forming atoms. Ring-forming carbon atoms and heteroatoms of a heterocycloalkyl group can be optionally oxidized to form an oxo or sulfido group or other oxidized linkage (e.g., C(O), S(O), C(S), S(O)₂, N-oxide, etc.) or a nitrogen atom can be quaternized. The heterocycloalkyl group can be attached through a ring-forming carbon atom or a ring-forming heteroatom. Heterocycloalkyl groups can include double bonds, for example, up to 3 double bonds. Examples of heterocycloalkyl groups include, but are not limited to, azetidinyl, dihydrofuranyl, dihydrothiophenyl, tetrahydrothiophenyl, tetrahydrofuranyl, tetrahydrotriazinyl, tetrahydropyrazolyl, tetrahydrooxazinyl, tetrahydropyrimidinyl, octahydrobenzofuranyl, octahydrobenzimidazolyl, octahydrobenzothiazolyl, imidazolidinyl, pyrrolidinyl, piperidinyl, piperazinyl, oxazolidinyl, thiazolidinyl, pyrazolidinyl, thiomorpholinyl, tetrahydropyranyl, tetrahydrothiazinyl, tetrahydrothiadiazinyl, tetrahydro-oxazolyl, morpholinyl, oxetanyl, dioxetanyl, dioxolanyl, dioxanyl, oxapanyl, dioxapanyl, oxacanyl, dioxacanyl, tetrahydrodiazinyl, oxazinyl, oxathiazinyl, quinuclidinyl, chromanyl, isochromanyl, dihydrobenzodioxinyl, benzodioxolyl, benzoxazinyl, indolinyl, dihydrobenzofuranyl, tetrahydroquinolyl, isochromyl, dihydro-1H-isoindolyl, 2-azabicyclo[2.2.1 ]heptanonyl, 3-azabicyclo[3.1.0]hexanyl, 3-azabicyclo[4.1.0]heptanyl, and the like. Further examples of heterocycloalkyl groups include tetrahydrofuran-2-yl, tetrahydrofuran-3-yl, imidazolidin-1-yl, imidazolidin-2-yl, imidazolidin-4-yl, pyrrolidin-1-yl, pyrrolidin-2-yl, pyrrolidin-3-yl, piperidin-1-yl, piperidin-2-yl, piperidin-3-yl, piperidin-4-yl, piperazin-1-yl, piperazin-2-yl, 1,3-oxazolidin-3-yl, 1,4-oxazepan-1-yl, isothiazolidinyl, 1,3-thiazolidin-3-yl, 1,2-pyrazolidin-2-yl, 1,2-tetrahydrothiazin-2-yl, 1,3-thiazinan-3-yl, 1,2-tetrahydrodiazin-2-yl, 1,3-tetrahydrodiazin-1-yl, 1,4-oxazin-4-yl, oxazolidinonyl, 2-oxo-piperidinyl (e.g., 2-oxo-piperidin-1-yl), and the like.

### Compositions

Provided herein are compositions including one or more monoglycerides of a C₄-C₂₈ fatty acid and a lecithin.

In some embodiments, the one or more monoglycerides are present in a total amount of about 10 wt % to about 90 wt %, about 10 wt % to about 80 wt %, about 10 wt % to about 65 wt, about 10 wt to about 50 wt %, about 50 wt to about 90 wt % to about 80 wt %, about 50 wt % to about 65 wt %, about 50 wt to about 65 wt %, about 65 wt % to about 90 wt %, about 65 wt % to about 80 wt %, or about 80 wt % to about 90 wt % of the composition.

In some embodiments, the lecithin is present in a total amount of about 10 wt % to about 90 wt, about 10 wt % to about 50 wt %, about 10 wt % to about 35 wt %, about 10 wt % to about 20 wt %, about 20 wt % to about 90 wt %, about 20 wt % to about 50 wt %, about 20 wt % to about 35 wt %, about 35 wt % to about 90 wt %, about 35 wt % to about 50 wt %, or about 50 wt to about 90 wt % of the composition.

In some embodiments, a ratio of a total mass of the one or more monoglycerides to a total mass of the lecithin is about 10:1 to about 1:10, for example, about 10:1 to about 1:9, about 10:1 to about 1:1 about 10:1 to about 2:1, about 10:1 to about 4:1, about 9:1 to about 1:10, about 9:1 to about 1:9, about 9:1 to about 1:1, about 9:1 to about 2:1, about 9:1 to about 4:1, about 4:1 to about 1:10, about 4:1 to about 1:9, about 4:1 to about 1:1, about 4:1 to about 2:1, about 2:1 to about 1:10, about 2:1 to about 1:9 about 2:1 to about 1:1, about 1: 1 to about 1:10, or about 1:1 to about 1:9.

In some embodiments, the one or more monoglycerides include one or more monoglycerides of a C₁₆-C₂₈ fatty acid, and one or more monoglycerides of a C₄-C₁₄ fatty acid. In certain such embodiments, the one or more monoglycerides of a C₄-C₁₄ fatty acid are present in a total amount of about 1 wt % to about 15 wt % of the composition. For example, in some embodiments, the one or more monoglycerides of a C₄-C₁₄ fatty acid are present in a total amount of about 1 wt % to about 10 wt %, about 1 wt to about 5 wt %, about 2 wt % to about 15 wt, about 2 wt % to about 10 wt %, or about 2 wt % to about 5 wt % of the composition. In another example, in some embodiments, a ratio of a total mass of the one or more monoglycerides of a C₄-C₁₄ fatty acid to the total mass of the lecithin is about 1:1 to about 1:100, for example, about 1:1 to about 1:15, about 1:7 to about 1:100, about 1:7 to about 1:15, or about 1:15 to about 1:100.

In some embodiments, the one or more monoglycerides are present in a total amount of about 50 wt % to about 65 wt % of the composition, and the lecithin is present in an amount of about 35 wt % to about 50 wt %. In certain such embodiments, the one or more monoglycerides of a C₄-C₁₄ fatty acid are present in a total amount of about 1 wt % to about 5 wt % of the composition. In some embodiments, the one or more monoglycerides are present in an amount of about 65 wt % to about 80 wt % of the composition, and the lecithin is present in an amount of about 20 wt % to about 35 wt % of the composition. In certain such embodiments, the one or more monoglycerides of a C₄-C₁₄ fatty acid are present in a total amount of about 1 wt % to about 5 wt % of the composition. In some embodiments, the one or more monoglycerides are present in an amount of about 80 wt % to about 90 wt % of the composition, and the lecithin is present in an amount of about 10 wt % to about 20 wt % of the composition. In certain such embodiments, the one or more monoglycerides of a C₄-C₁₄ fatty acid are present in a total amount of about 2 wt % to about 15 wt % of the composition.

In some embodiments, the ratio of the total mass of the one or more monoglycerides to the total mass of the lecithin is about 2:1 to about 1:1. In certain such embodiments, the ratio of a total mass of the one or more monoglycerides of a C₄-C₁₄ fatty acid to the total mass of the lecithin is about 1:15 to about 1:100. In some embodiments, the ratio of the total mass of the one or more monoglycerides to the total mass of the lecithin is about 4:1 to about 2:1. In certain such embodiments, the ratio of a total mass of the one or more monoglycerides of a C₄-C₁₄ fatty acid to the total mass of the lecithin is about 1:7 to about 1:100.

In some embodiments, the one or more monoglycerides and the lecithin are present in an amount of at least about 80 wt % of the composition, for example, at least about 85 wt %, at least about 90 wt %, at least about 95 wt %, at least about 97.5 wt %, at least about 98 wt %, or at least about 99 wt % of the composition.

Also provided herein are compositions including one or more monoglycerides of a C₄-C₂₈ fatty acid, one or more alkyl esters of a C₄-C₂₈ fatty acid, and a lecithin. In some embodiments, a ratio of a total mass of the one or more monoglycerides to a total mass of the one or more alkyl esters is about 20:1 to about 1:1, for example, about 20:1 to about 2:1, about 20:1 to about 5:1, about 15:1 to about 1:1, about 15:1 2:1, about 15:1 to about 5:1, about 10:1 to about 1:1, about 10: 1 to about 2:1, or about 10:1 to about 5:1. In some embodiments, a ratio of a total mass of the one or more monoglycerides and the one or more alkyl esters to a total mass of the lecithin is about 10:1 to about 1:10, for example, about 10:1 to about 1:5, about 10:1 to about 1:2, about 5:1 to about 1:10, about 5:1 to about 1:5, about 5:1 to about 1:2, about 2:1 to about 1:10, about 2:1 to about 1:5, about 2:1 to about 1:2.

In some embodiments, the one or more monoglycerides and the one more alkyl esters are present in a total amount of about 10 wt % to about 90 wt %, about 10 wt % to about 75 wt %, about 10 wt % to about 50 wt %, about 25 wt % to about 90 wt %, about 25 wt % to about 75 wt %, about 25 wt % to about 50 wt %, about 50 wt % to about 90 wt %, or about 50 wt % to about 75 wt % of the composition. In some embodiments, the lecithin is present in a total amount of about 10 wt % to about 90 wt %, about 10 wt % to about 75 wt %, about 10 wt % to about 50 wt %, about 25 wt % to about 90 wt %, about 25 wt % to about 75 wt %, about 25 wt % to about 50 wt %, about 50 wt % to about 90 wt %, or about 50 wt % to about 75 wt % of the composition.

In some embodiments, the one or more monoglycerides, the one or more alkyl esters, and the lecithin are present in an amount of at least about 80 wt % of the composition, for example, at least about 85 wt %, at least about 90 wt %, at least about 95 wt %, at least about 97.5 wt %, at least about 98 wt %, or at least about 99 wt % of the composition.

### Lecithins

In some embodiments, the lecithin includes a composition identified as E322 (authorized food additive) by the European Food Safety Authority (EFSA). In some embodiments, the lecithin includes a composition identified as Chemical Abstract Service (CAS) No. 8002-43-5, identified by the U.S. Food and Drug Agency (FDA) as generally recognized as safe (GRAS). In some embodiments, the lecithin includes a soybean lecithin, a sunflower lecithin, or a rapeseed lecithin. In some embodiments, the lecithin includes a hydrolyzed lecithin (also referred to as a lysolecithin).

In some embodiments, the lecithin includes one or more glycerophospholipids. For example, in some embodiments, the lecithin includes about 20 wt % to about 60 wt %, about 20 wt % to about 50 wt %, about 20 wt % to about 40 wt %, about 30 wt % to about 60 wt %, about 30 wt % to about 50 wt %, about 30 wt % to about 40 wt %, about 40 wt % to about 60 wt %, or about 40 wt % to about 50 wt % of the composition. In some embodiments, the lecithin includes one or more triglycerides. For example, in some embodiments, the lecithin includes about 5 wt % to about 50 wt %, about 5 wt % to about 50 wt %, about 5 wt % to about 40 wt %, about 5 wt % to about 30 wt %, about 10 wt % to about 50 wt %, about 10 wt % to about 40 wt %, about 10 wt % to about 30 wt %, about 20 wt % to about 50 wt %, about 20 wt % to about 40 wt %, or about 20 wt % to about 30 wt % of the composition.

Also provided herein are compositions including one or more monoglycerides of a C₄-C₂₈ fatty acid, and one or more glycerophospholipids. In some embodiments, the composition includes about 4 wt % to about 40 wt % of the one or more glycerophospholipids, for example, about 4 wt % to about 25 wt %, about 4 wt % to about 15 wt %, about 8 wt to about 40 wt %, about 8 wt % to about 25 wt %, or about 8 wt % to about 15 wt % of the composition. In some embodiments, the composition further includes one or more triglycerides. For example, in some embodiments, the composition includes about 3 wt % to about 35 wt %, about 3 wt % to about 20 wt %, about 3 wt % to about 15 wt %, about 6 wt % to about 35 wt %, about 6 wt % to about 20 wt %, or about 6 wt % to about 15 wt % of the one or more triglycerides.

### Glycerophospholipids

In some embodiments, the one or more glycerophospholipids include a phosphatidylcholine, a lysophosphatidylcholine, a phosphatidylethanolamine, a lysophosphatidylethanolamine, a phosphatidylinositol, a lysophosphatidylinositol, a phosphatidylserine, a lysophosphatidylserine, a phosphatidic acid, a lysophosphatidic acid, or any combination thereof. In some embodiments, the one or more glycerophospholipids include a phosphatidylcholine, a phosphatidylethanolamine, a phosphatidylinositol, and a phosphatidic acid. In some embodiments, the one or more glycerophospholipids include a phosphatidylserine. In some embodiments, the one or more glycerophospholipids independently includes one or more C₈-C₂₂ side chains. For example, in some embodiments, the one or more glycerophospholipids independently includes one or more C₁₆ side chains, one or more C₁₈ side chains, or both.

In some embodiments, one or more of the glycerophospholipids independently includes a compound of Formula III:

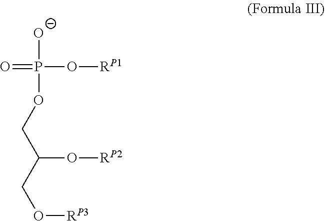

wherein:

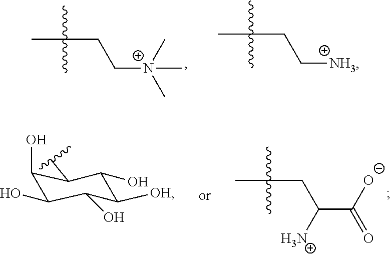

each R^{P1} is independently —H,
each R^{P2} and R^{P3} is independently —H or —C(O)R^{H};
at least one of R^{P2} and R^{P3} is not —H; and
each R^{H} is independently a C₇-C₂₁ side chain.

In some embodiments of Formula III, one of R^{P2} and R^{P3} is —H. In some embodiments of Formula III, each of R^{P2} and R^{P3} is independently —C(O)R^{H}. In some embodiments of Formula III, each R^{H} is independently a C₁₁-C₂₁ side chain. In some embodiments of Formula III, each R^{H} is independently a C₁₅ or C₁₇ side chain. In some embodiments of Formula III, each R^{H} is independently an unsubstituted side chain. In some embodiments of Formula III, each R^{H} is independently a saturated side chain, a mono-unsaturated side chain, a di-unsaturated side chain, or a tri-unsaturated side chain.

### Triglycerides

In some embodiments, the one or more triglycerides independently includes one or more C₈-C₂₂ side chains. For example, in some embodiments, the one or more triglycerides independently includes one or more C₁₆ side chains, one or more C₁₈ side chains, or both.

In some embodiments, one or more of the triglycerides independently includes a compound of Formula IV:

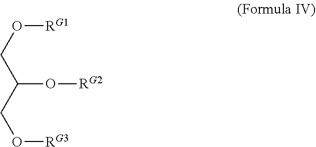

wherein:

each R^{G1}, R^{G2}, and R^{G3} is independently —C(O)R^{H}, and

each R^{H} is independently a C₇-C₂₁ side chain.

In some embodiments of Formula IV, each R^{H} is independently a C₁₅ or C₁₇ side chain. In some embodiments of Formula IV, each R^{H} is independently an unsubstituted side chain. In some embodiments of Formula IV, each R^{H} is independently a saturated side chain, a mono-unsaturated side chain, a di-unsaturated side chain, or a tri-unsaturated side chain.

In some embodiments of Formula III or Formula IV, each R^{H} is independently:

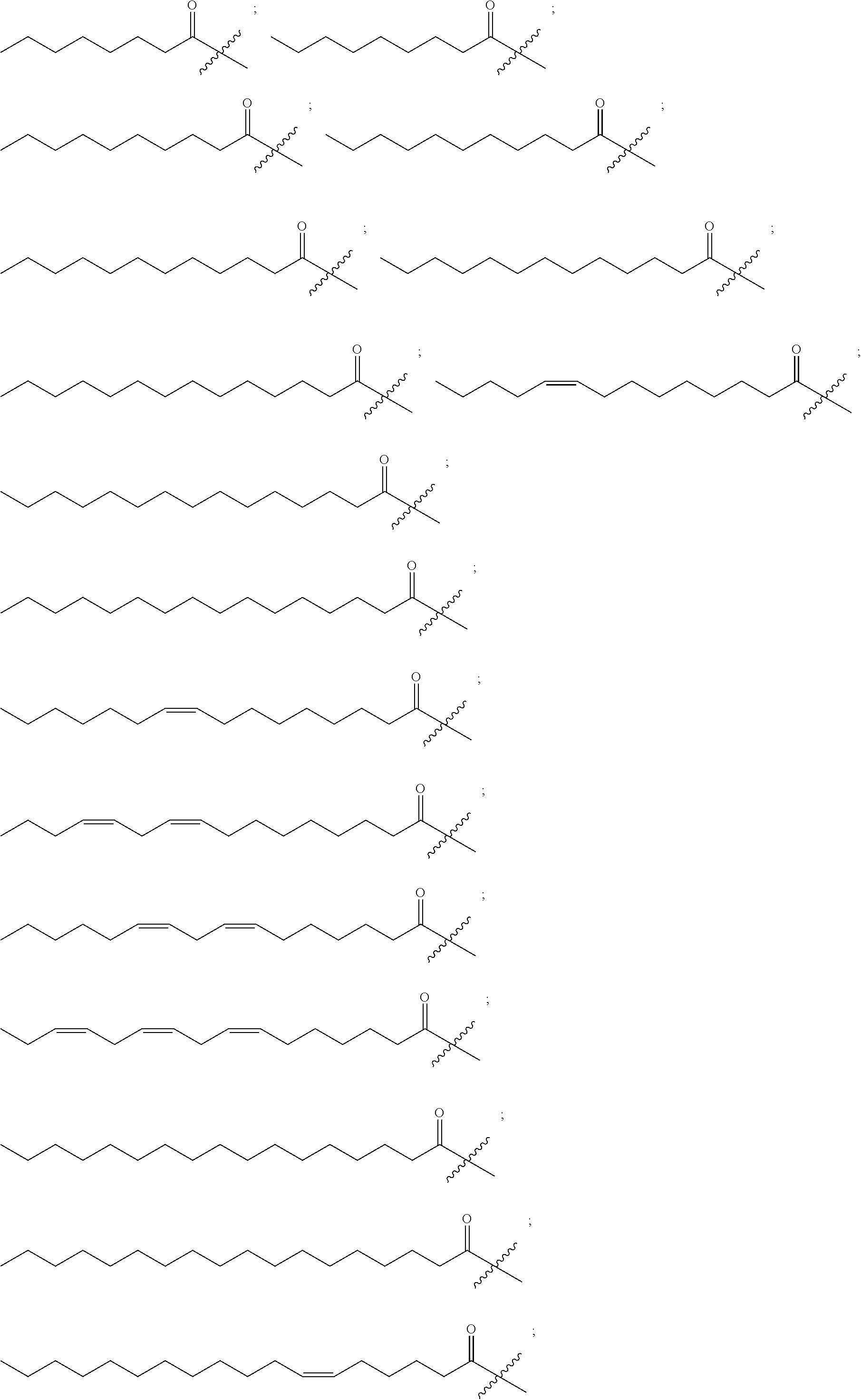

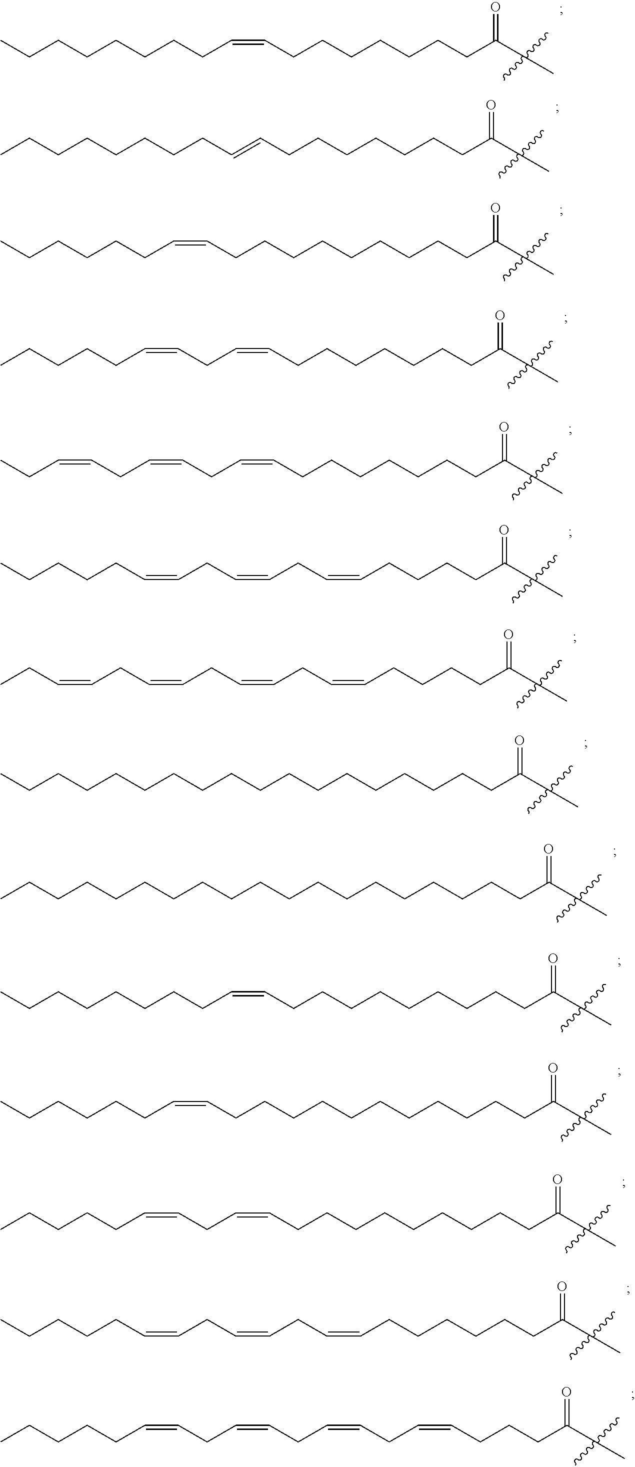

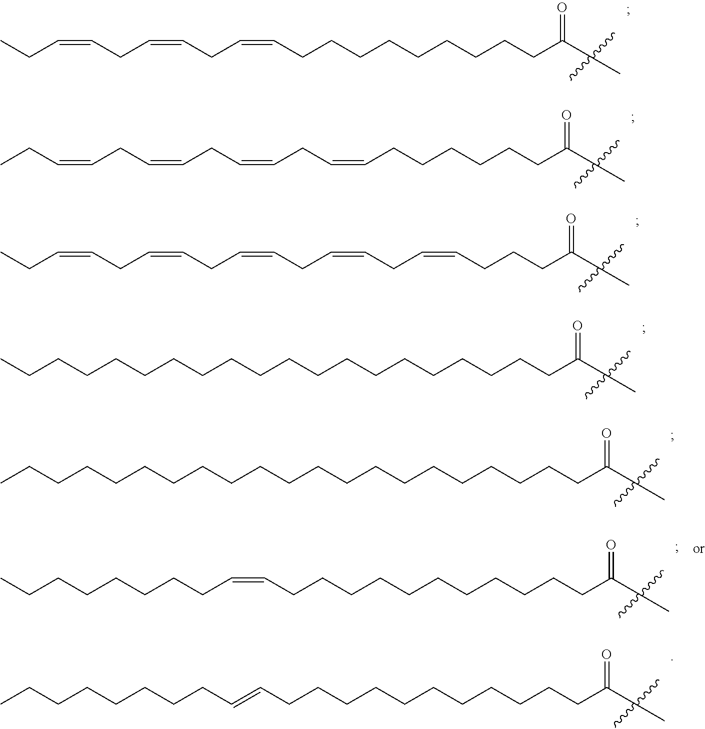

Monoglycerides of a C₄-C₂₈ Fatty Acid

The compositions described herein include one or more monoglycerides of a C₄-C₂₈ fatty acid. In some embodiments, the composition includes one monoglyceride of a C₄-C₂₈ fatty acid. In some embodiments, the composition includes two, three, or more monoglycerides of a C₄-C₂₈ fatty acid, for example, two monoglycerides of a C₄-C₂₈ fatty acid. In certain such embodiments, the composition includes one or more monoglycerides of a C₁₆-C₂₈ fatty acid and one or more monoglycerides of a C₄-C₁₄ fatty acid. In some embodiments, the monoglycerides include one or more monoglycerides of a naturally occurring fatty acid.

The monoglycerides can include one or more 1-monoglycerides, one or more 2-monoglycerides, or a mixture thereof. In some embodiments, the monoglycerides include one or more 2,3-dihydroxypropan-1-yl esters of a fatty acid, one or more 1,3-dihydroxypropan-2-yl esters of a fatty acid, or a mixture thereof. In some embodiments, 1-monoglycerides make up at least about 50 wt %, at least about 70 wt %, at least about 80 wt %, at least about 90 wt %, or about 100 wt % of the monoglycerides present in the composition. In some embodiments, 1-monoglycerides make up about 70 wt % to about 100 wt %, about 70 wt % to about 90 wt %, about 75 wt % to about 100 wt %, about 75 wt % to about 90 wt %, about 80 wt % to about 100 wt %, or about 80 wt % to about 90 wt % of the monoglycerides present in the composition.

In some embodiments, the monoglycerides include one or more monoglycerides of a C₆-C₂₈ fatty acid, a C₈-C₂₈ fatty acid, a C₄-C₂₄ fatty acid, a C₆-C₂₄ fatty acid, a C₁₂-C₂₄ fatty acid, a C₄-C₂₂ fatty acid, a C₆-C₂₂ fatty acid, or a C₁₂-C₂₂ fatty acid. In some embodiments, one or more of the monoglycerides include an unsubstituted side chain, for example, an unsubstituted C₁₂-C₂₂ side chain. In some embodiments, one or more of the monoglycerides include a linear side chain, for example, a linear C₁₂-C₂₂ side chain. In some embodiments, one or more of the monoglycerides include a saturated side chain, for example, a saturated C₁₂-C₂₂ side chain.

In some embodiments, the monoglycerides include one or more compounds of Formula I-i:

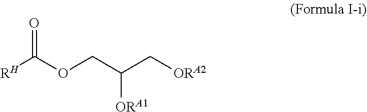

wherein:

R^{A1} and R^{A2} are each independently selected from H and C₁-C₆ alkyl; and
R^{H} is a C₃-C₂₇ side chain.

In some embodiments, the monoglycerides include one or more compounds of Formula I-ii:

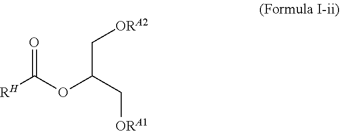

wherein:

R^{A1} and R^{A2} are each independently selected from H and C₁-C₆ alkyl; and

R^{H} is a C₃-C₂₇ side chain.

In some embodiments, each of the one or more monoglycerides independently includes a compound of Formula I-i or Formula I-ii. In some embodiments of Formula I-i or Formula I-ii, R^{A1} and R^{A2} are each H. In some embodiments of Formula I-i or Formula I-ii, R^{H} is a saturated side chain. In some embodiments of Formula I-i or Formula I-ii, R^{H} is an unsubstituted side chain. In some embodiments of Formula I-i or Formula I-ii, R^{H} is a linear side chain. In some embodiments of Formula I-i or Formula I-ii, R^{H} is a C₅-C₁₇ side chain. In some embodiments of Formula I-i or Formula I-ii, R^{H} is a C₁₁-C₂₁ side chain.

In some embodiments, the monoglycerides include a first compound of Formula I-i or Formula I-ii, where R^{H} is a C₁₅-C₂₇ side chain; and a second compound of Formula I-i or Formula I-ii, where R^{H} is a C₃-C₁₃ side chain. In some embodiments, R^{H} of the first compound is a C₁₅-C₂₁ side chain, and R^{H} of the second compound is a C₁₁-C₁₃ side chain.

In some embodiments, the monoglycerides include one or more compounds of Formula IA-i:

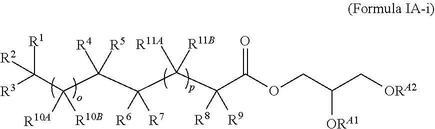

wherein:
R^{A1} and R^{A2} are each independently selected from H and C₁-C₆ alkyl;
R¹, R², R³, R⁴, R⁵, R⁶, R⁷, R⁸, and R⁹ are each independently selected from H, OH, C₁-C₆ alkyl, C₂-C₆ alkenyl, and C₁-C₆ alkoxy;
each occurrence of R^{10A}, R^{10B}, R^{11A}, and R^{11B} is independently selected from H, OH, C₁-C₆ alkyl, C₂-C₆ alkenyl, and C₁-C₆ alkoxy;
any two of R¹, R², R³, R⁴, R⁵, R⁶, R⁷, R⁸, R⁹, R^{10A}, R^{10B}, R^{11A}, and R^{11B} on adjacent carbon atoms can be taken together with the carbon atoms to which they are attached to form a double bond, a 3- to 6-membered ring heterocycloalkyl, or a C₃-C₆ cycloalkyl;
o is an integer from 0 to 17;
p is an integer from 0 to 17; and
the sum of o and p is from 0 to 17.

In some embodiments, the monoglycerides include one or more compounds of Formula IA-ii:

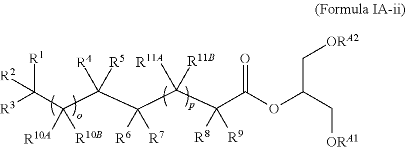

wherein:
R^{A1} and R^{A2} are each independently selected from H and C₁-C₆ alkyl;
R¹, R², R³, R⁴, R⁵, R⁶, R⁷, R⁸, and R⁹ are each independently selected from H, OH, C₁-C₆ alkyl, C₂-C₆ alkenyl, and C₁-C₆ alkoxy;
each occurrence of R^{10A}, R^{10B}, R^{11A}, and R^{11B} is independently selected from H, OH, C₁-C₆ alkyl, C₂-C₆ alkenyl, and C₁-C₆ alkoxy;
any two of R¹, R², R³, R⁴, R⁵, R⁶, R⁷, R⁸, R⁹, R^{10A}, R^{10B}, R^{11A}, and R^{11B} on adjacent carbon atoms can be taken together with the carbon atoms to which they are attached to form a double bond, a 3- to 6-membered ring heterocycloalkyl, or a C₃-C₆ cycloalkyl;
o is an integer from 0 to 17;
p is an integer from 0 to 17; and
the sum of o and p is from 0 to 17.

In some embodiments, each of the one or more monoglycerides independently includes a compound of Formula IA-i or Formula IA-ii. In some embodiments of Formula IA-i or Formula IA-ii, R^{A1} and R^{A2} are each H. In some embodiments of Formula IA-i or Formula IA-ii, each of R¹, R², R³, R⁴, R⁵, R⁶, R⁷, R⁸, and R⁹, and each occurrence of R^{10A}, R^{10B}, R¹¹, and R^{11B} are independently selected from H and OH. In some embodiments of Formula IA-i or Formula IA-ii, any two of R¹, R², R³, R⁴, R⁵, R⁶, R⁷, R⁸, R⁹, R^{10A}, R^{10B}, R^{11A}, and R^{11B} on adjacent carbon atoms are taken together with the carbon atoms to which they are attached to form an oxirane. In some embodiments of Formula IA-i or Formula IA-ii, two pairs, one pair, or none of R¹, R², R³, R⁴, R⁵, R⁶, R⁷, R⁸, and R⁹, and each occurrence of R^{10A}, R^{10B}, R^{11A}, and R^{11B} on adjacent carbon atoms are taken together with the carbon atoms to which they are attached to form a double bond. In some embodiments of Formula IA-i or Formula IA-ii, one pair, or none of R¹, R², R³, R⁴, R⁵, R⁶, R⁷, R⁸, and R⁹, and each occurrence of R^{10A}, R^{10B}, R^{11A}, and R^{11B} on adjacent carbon atoms are taken together with the carbon atoms to which they are attached to form an oxirane. In some embodiments of Formula IA-i or Formula IA-ii, two, one, or none of R¹, R², R³, R⁴, R⁵, R⁶, R⁷, R⁸, and R⁹, and each occurrence of R^{10A}, R^{10B}, R^{11A}, and R^{11B} are OH.

In some embodiments of Formula IA-i or Formula IA-ii, the sum of o and p is from 0 to 13, from 0 to 11, from 0 to 9, from 0 to 7, from 5 to 17, from 5 to 13, from 5 to 11, from 5 to 9, from 5 to 7, from 7 to 17, from 7 to 13, from 7 to 11, from 7 to 9, from 9 to 17, from 9 to 13, from 9 to 11, from 11 to 17, or from 11 to 13.

In some embodiments, the monoglycerides include one or more 1-monoglycerides or 2-monoglycerides, for example, 2,3-dihydroxypropan-1-yl esters or 1,3-dihydroxypropan-2-yl esters, of heptanoic acid, octanoic acid, nonanoic acid, decanoic acid, undecanoic acid, dodecanoic acid, tridecanoic, tetradecanoic acid, pentadecanoic acid, hexadecanoic acid, heptadecanoic acid, octadecanoic acid, nonadecanoic acid, eicosanoic acid, heneicosanoic acid or docosanoic acid.

### Alkyl Esters

The compositions described herein include one or more alkyl esters of a C₄-C₂₈ fatty acid. In some embodiments, the alkyl esters include one or more C₁-C₅ alkyl esters. In some embodiments, each of the alkyl esters is independently a C₁-C₅ alkyl ester. In some embodiments, the alkyl esters include a methyl ester, an ethyl ester, a propyl ester, an isopropyl ester, a tert-butyl ester, an iso-amyl ester, or any combination thereof. In some embodiments, at least one of the alkyl esters includes an ethyl ester or propyl ester.

In some embodiments, the alkyl esters include one or more compounds of Formula V:

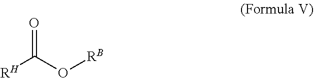

wherein:
R^{B} is C₁-C₈ alkyl; and
R^{H} is a C₇-C₁₉ side chain.

In some embodiments, each of the one or more alkyl esters independently includes a compound of Formula V. In some embodiments of Formula V, R^{B} is C₁-C₅ alkyl, C₁-C₃ alkyl, C₂ alkyl, or C₃ alkyl. In some embodiments of Formula V, R^{H} is a saturated side chain. In some embodiments of Formula V, R^{H} is an unsubstituted side chain. In some embodiments of Formula V, R^{H} is a linear side chain. In some embodiments of Formula V, R^{H} is a C₇-C₁₇ side chain, C₉-C₁₉ side chain, a C₉-C₁₇ side chain, a C₁₁-C₁₉ side chain, or a C₁₁-C₁₇ side chain.

In some embodiments, the alkyl esters include one or more compounds of Formula VA:

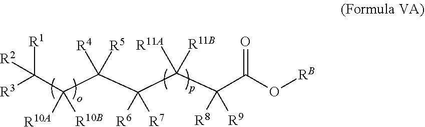

wherein:
R^{B} is C₁-C₈ alkyl;
R¹, R², R³, R⁴, R⁵, R⁶, R⁷, R⁸, and R⁹ are each independently selected from H, OH, C₁-C₆ alkyl, C₂-C₆ alkenyl, and C₁-C₆ alkoxy;
each occurrence of R^{10A}, R^{10B}, R^{11A}, and R^{11B} is independently selected from H, OH, C₁-C₆ alkyl, C₂-C₆ alkenyl, and C₁-C₆ alkoxy;
any two of R¹, R², R³, R⁴, R⁵, R⁶, R⁷, R⁸, R⁹, R^{10A}, R^{10B}, R^{11A}, and R^{11B} on adjacent carbon atoms can be taken together with the carbon atoms to which they are attached to form a double bond, a 3- to 6-membered ring heterocycloalkyl, or a C₃-C₆ cycloalkyl;
o is an integer from 0 to 15;
p is an integer from 0 to 15; and
the sum of o and p is from 3 to 15.

In some embodiments, each of the one or more alkyl esters independently includes a compound of Formula VA. In some embodiments of Formula VA, R^{B} is C₁-C₅ alkyl, C₁-C₃ alkyl, C₂ alkyl, or C₃ alkyl. In some embodiments of Formula VA, each of R¹, R², R³, R⁴, R⁵, R⁶, R⁷, R⁸, and R⁹, and each occurrence of R^{10A}, R^{10B}, R^{11A}, and R^{11B} are independently selected from H and OH. In some embodiments of Formula VA, any two of R¹, R², R³, R⁴, R⁵, R⁶, R⁷, R⁸, R⁹, R^{10A}, R^{10B}, R^{11A}, and R^{11B} on adjacent carbon atoms are taken together with the carbon atoms to which they are attached to form an oxirane. In some embodiments of Formula VA, two pairs, one pair, or none of R¹, R², R³, R⁴, R⁵, R⁶, R⁷, R⁸, and R⁹, and each occurrence of R^{10A}, R^{10B}, R^{11A}, and R^{11B} on adjacent carbon atoms are taken together with the carbon atoms to which they are attached to form a double bond. In some embodiments of Formula VA, one pair, or none of R¹, R², R³, R⁴, R⁵, R⁶, R⁷, R⁸, and R⁹, and each occurrence of R^{10A}, R^{10B}, R^{11A}, and R^{11B} on adjacent carbon atoms are taken together with the carbon atoms to which they are attached to form an oxirane. In some embodiments of Formula VA, two, one, or none of R¹, R², R³, R⁴, R⁵, R⁶, R⁷, R⁸, and R⁹, and each occurrence of R^{10A}, R^{10B}, R^{11A}, and R^{11B} are —OH.

In some embodiments, the one or more alkyl esters include, for example, methyl, ethyl, propyl, or butyl esters, of heptanoic acid, octanoic acid, nonanoic acid, decanoic acid, undecanoic acid, dodecanoic acid, tridecanoic, tetradecanoic acid, pentadecanoic acid, hexadecanoic acid, heptadecanoic acid, octadecanoic acid, nonadecanoic acid, eicosanoic acid, heneicosanoic acid or docosanoic acid.

### Additional Components

The compositions described herein can include one or more additional components, for example, components that are non-toxic and safe for consumption by humans and/or animals. For example, the composition can include direct or indirect food additives or food-contact substances approved by the U.S. Food and Drug Administration (FDA), components satisfying FDA regulatory requirements to be used as a food additive or food contact substance, or components generally recognized as safe (GRAS) by the FDA.

In some embodiments, the compositions described herein further include one or more fatty acids, for example, C₄-C₂₂ fatty acids. In some embodiments, the composition includes less than about 10 wt %, for example, less than about 5 wt %, less than about 2 wt %, less than about 1 wt %, or is free from one or more of triglycerides, diglycerides, acetylated monoglycerides, lactlyated monoglycerides, succinylated monoglycerides, sterols, bile acids, proteins, polysaccharides, phenols, lignans, aromatic acids, terpenoids, flavonoids, carotenoids, alkaloids, alcohols, alkanes, aldehydes, and any salts thereof.

### Mixtures

Also provided herein are mixtures including a composition described herein and a solvent. In some embodiments, the mixture is a colloidal dispersion (e.g., an emulsion) of a composition described herein in a solvent. In some embodiments, the solvent includes water, ammonia, methanol, ethanol, isopropanol, butanol, acetone, ethyl acetate, chloroform, acetonitrile, tetrahydrofuran, diethyl ether, methyl tert-butyl ether, or any combination thereof. In some embodiments, the solvent includes water, ethanol, or a combination thereof. In some embodiments, the solvent includes water and one or more of ammonia, methanol, ethanol, isopropanol, butanol, acetone, ethyl acetate, chloroform, acetonitrile, tetrahydrofuran, diethyl ether, and methyl tert-butyl ether. In some embodiments, the solvent includes water and ammonia.

In some embodiments, the mixture includes about 30 wt % to about 99.9 wt %, about 30 wt % to about 99.5 wt %, about 30 wt % to about 99 wt %, about 50 wt % to about 99.9 wt %, about 50 wt % to about 99.5 wt %, about 50 wt % to about 99 wt %, about 90 wt % to about 99.9 wt %, about 90 wt % to about 99.5 wt %, or about 90 wt % to about 99 wt % of solvent.

In some embodiments, the concentration of the composition in the mixture is about 1 mg/mL to about 200 mg/mL, about 1 mg/mL to about 150 mg/mL, about 1 mg/mL to about 125 mg/mL, about 1 mg/mL to about 100 mg/mL, about 25 mg/mL to about 200 mg/mL, about 25 mg/mL to about 150 mg/mL, about 25 mg/mL to about 125 mg/mL, about 25 mg/mL to about 100 mg/mL, about 50 mg/mL to about 200 mg/mL, about 50 mg/mL to about 150 mg/mL, about 50 mg/mL to about 125 mg/mL, or about 50 mg/mL to about 100 mg/mL.

### Coatings

Also provided herein are coated agricultural products including a layer formed from a composition or mixture described herein, disposed on a surface of the agricultural product. In some embodiments, the agricultural product is an edible agricultural product including, for example, fruits, vegetables, edible seeds and nuts, herbs, spices, produce, meat, eggs, dairy products, seafood, grains, or any other consumable item. In other embodiments, the agricultural product is an inedible agricultural product including, for example, inedible flowers, seeds, shoots, stems, leaves, whole plants, and the like. In some embodiments, the layer is disposed on an exterior surface (e.g., a cuticular surface) of the agricultural product.

In some embodiments, the layer has a thickness of about 0.1 μm to about 20 μm, for example, about 0.1 μm to about 15 μm, about 0.1 μm to about 10 μm, about 0.5 μm to about 20 um, about 0.5 μm to about 15 μm, about 0.5 μm to about 10 μm, about 1 μm to about 20 μm, about 1 μm to about 15 μm, or about 1 μm to about 10 μm.

### Coating Methods

Also provided herein are methods for coating an agricultural product, the methods including contacting a surface of the agricultural product with a mixture including a coating agent and a solvent, and removing at least a portion of the solvent to form a coating on the surface of the agricultural product. The coating agent includes one or more monoglycerides of a C₄-C₂₈ fatty acid, and a lecithin. In some embodiments, the coating agent is a composition described herein. For example, in some embodiments, a ratio of a total mass of the one or more monoglycerides to a total mass of the lecithin is about 10:1 to about 1:10. In some embodiments, the coating agent one or more monoglycerides of a C₄-C₂₈ fatty acid, present in a total amount of about 10 wt % to about 90 wt % of the composition, and a lecithin, present in an amount of about 10 wt % to about 90 wt % of the composition. In some embodiments, the coating agent further includes one or more alkyl esters of a C₈-C₂₀ fatty acid. In certain such embodiments, a ratio of a total mass of the one or more monoglycerides to a total mass of the one or more alkyl esters is about 20:1 to about 1:1. In some embodiments, the one or more monoglycerides and the one more alkyl esters are present in a total amount of about 10 wt % to about 90 wt % of the composition.

In some embodiments of the coating method, the agricultural product is an edible agricultural product including, for example, fruits, vegetables, edible seeds and nuts, herbs, spices, produce, meat, eggs, dairy products, seafood, grains, or any other consumable item. In other embodiments of the coating method, the agricultural product is an inedible agricultural product including, for example, inedible flowers, seeds, shoots, stems, leaves, whole plants, and the like. In some embodiments, the method includes contacting an exterior surface (e.g., a cuticular surface) of the agricultural product with the coating agent-containing mixture.

In some embodiments of the coating method, contacting the surface of the agricultural product includes spraying the mixture onto the surface of the agricultural product. The mixture can be sprayed, for example, from a commercially available sprayer. In some embodiments, the mixture is aerosol-sprayed onto the surface of the agricultural product. In some embodiments of the coating method, contacting the surface of the agricultural product includes immersing the agricultural product in the mixture. In other embodiments of the coating method, the mixture can be brushed, dripped, drop-cast, rolled, dabbed, or poured on the surface of the agricultural product.

In some embodiments of the coating method, the solvent includes water, methanol, ethanol, isopropanol, butanol, acetone, ethyl acetate, chloroform, acetonitrile, tetrahydrofuran, diethyl ether, methyl tert-butyl ether, or any combination thereof. In some embodiments of the coating method, the solvent includes water, ethanol, or a combination thereof. In some embodiments, the solvent includes water and one or more of ammonia, methanol, ethanol, isopropanol, butanol, acetone, ethyl acetate, chloroform, acetonitrile, tetrahydrofuran, diethyl ether, and methyl tert-butyl ether. In some embodiments, the solvent includes water and ammonia.

In some embodiments of the coating method, the concentration of the coating agent in the mixture is about 1 mg/mL to about 200 mg/mL, about 1 mg/mL to about 150 mg/mL, about 1 mg/mL to about 125 mg/mL, about 1 mg/mL to about 100 mg/mL, about 25 mg/mL to about 200 mg/mL, about 25 mg/mL to about 150 mg/mL, about 25 mg/mL to about 125 mg/mL, about 25 mg/mL to about 100 mg/mL, about 50 mg/mL to about 200 mg/mL, about 50 mg/mL to about 150 mg/mL, about 50 mg/mL to about 125 mg/mL, or about 50 mg/mL to about 100 mg/mL.

In some embodiments of the coating method, removing at least a portion of the solvent includes evaporating at least a portion of the solvent. In some embodiments, the evaporation can be passive. In other embodiments, the evaporation can be active, for example, as in convective drying. In some embodiments, removing at least a portion of the solvent includes evaporating at least a portion of the solvent at a temperature of less than 40° C., for example, less than 35° C., or less than 30° C. In some embodiments, removing at least a portion of the solvent includes evaporating at least a portion of the solvent at a temperature of 10° C. to about 40° C., or about 10° ° C. to about 30° C. In some embodiments, removing at least a portion of the solvent includes evaporating at least a portion of the solvent at ambient temperature.

### EXAMPLES

### Example 1. Crystallinity of Lecithin-Containing Mixtures

Coating agents A-E having the compositions shown in Table 1 were prepared.

TABLE 1
Coating Agent Compositions

| | A | B | C | D | E |
|---|---|---|---|---|---|
| Glyceryl | — | 25 wt % | 45 wt % | 70 wt % | 85 wt % |
| Monostearate¹ | | | | | |
| Glyceryl | — | 4 wt % | 5 wt % | 4 wt % | — |
| Monolaurate² | | | | | |
| Lecithin³ | 100 wt % | 71 wt % | 50 wt % | 26 wt % | 15 wt % |

¹mixture of 2,3-dihydroxypropan-1-yl octadecanoate and 1,3-dihydroxypropan-2-yl octadecanoate (molar ratio of 2,3-dihydroxypropan-1-yl octadecenoate: 1,3-dihydroxypropan-2-yl octadecanoate of about 85:15 to about 95:5)
²mixture of 2,3-dihydroxypropan-1-yl laurate and 1,3-dihydroxypropan-2-yl laurate (molar ratio of 2,3-dihydroxypropan-1-yl laurate: 1,3-dihydroxypropan-2-yl laurate of about 85:15 to about 95:5)
³sunflower lecithin (Lasenor Giralec P powder)

Mixtures 1-6 of coating agents A-E dispersed in water at the concentrations shown in Table 2 were prepared.

TABLE 2
Mixtures

| | Coating Agent | Concentration |
|---|---|---|
| Mixture 1 | A | 50 g/L |
| Mixture 2 | B | 50 g/L |
| Mixture 3 | C | 50 g/L |
| Mixture 4 | D | 50 g/L |
| Mixture 5 | E | 50 g/L |
| Mixture 6 | A | 150 g/L |

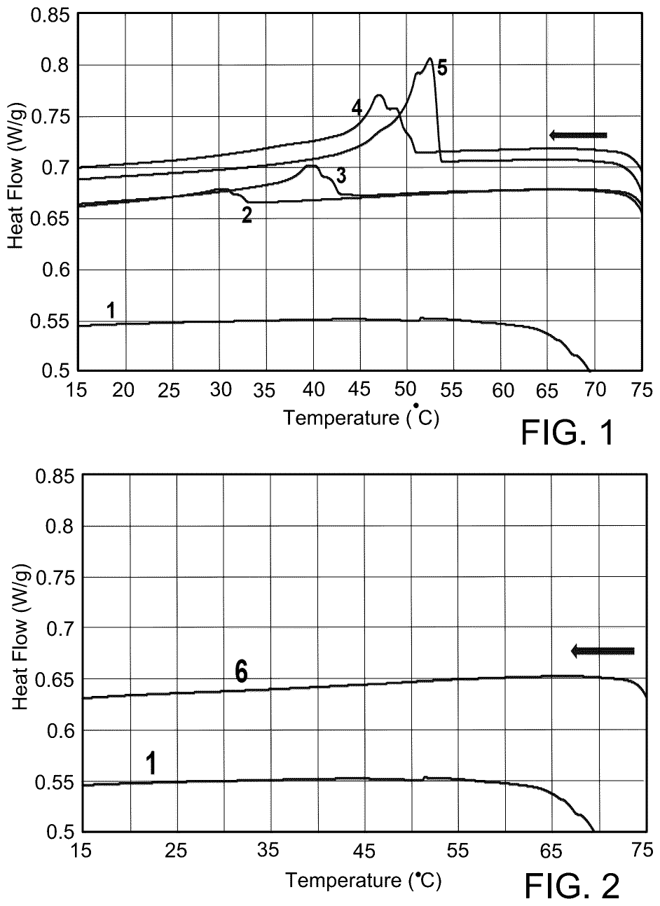

8-12 mg samples of each mixture were loaded into hermetically sealed sample pans and analyzed using a differential scanning calorimeter (DSC). Samples were subjected to two heating and cooling cycles: Heating Cycle 1: 20° C.→70-8° C. at a rate of 10° C./min; Cooling Cycle 1: 70-80° C.->10° C. at a rate of −10° C./min; Heating Cycle 2: 10 C→70-80 C at a rate of 10° C./min; Cooling Cycle 2: 70-80° C.→10° C. at a rate of −10° C./min. Results of the second cooling cycle were identical to that of the first cooling cycle. The DSC results for mixtures 1-5, shown in FIG. 1, indicated that crystallinity increases with decreasing lecithin content. FIG. 2 compares the DSC curves for mixtures 1 and 6, which indicated that no correlation between crystallization peak and concentration existed.

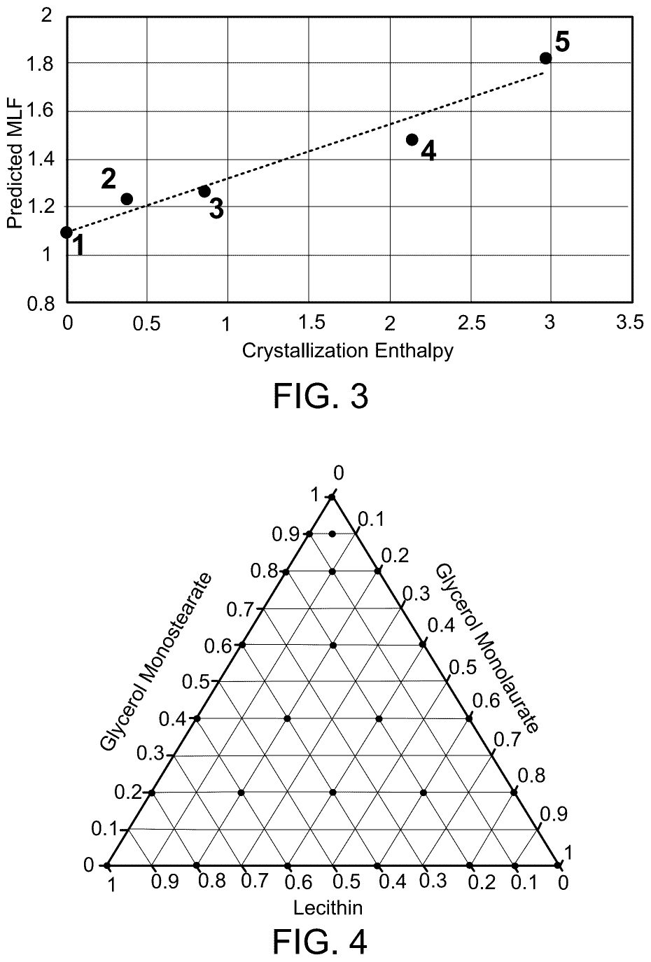

The mass loss factor (MLF; ratio of the average mass loss rate of untreated produce to the average mass loss rate of coated produce for a given period of time) of produce coated with each of Mixtures 1-5 was predicted using a model based on the space-filling mixture design of experiment (DoE) of Example 3, below, and then plotted against the respective crystallization enthalpy (calculated by integrating the peaks shown in FIG. 1). The resulting graph is shown in FIG. 3. A linear fit of the points (y=0.2223x+1.0962; R²=0.9525) indicated correlation between barrier performance and coating crystallinity.

### Example 2. Stability/Mixibility Mapping of Lecithin-Containing Formulations

A space-filling mixture design of experiment (DoE) was performed for a coating agent including combinations of sunflower lecithin (mass fraction 0-1), glyceryl monostearate (mass fraction 0-1), and glyceryl monolaurate (mass fraction 0-1) dispersed in water (50 g/L). The initial design space is shown in FIG. 4. Each formulation indicated in FIG. 4 (black dots) was tested for mixibility and stability.

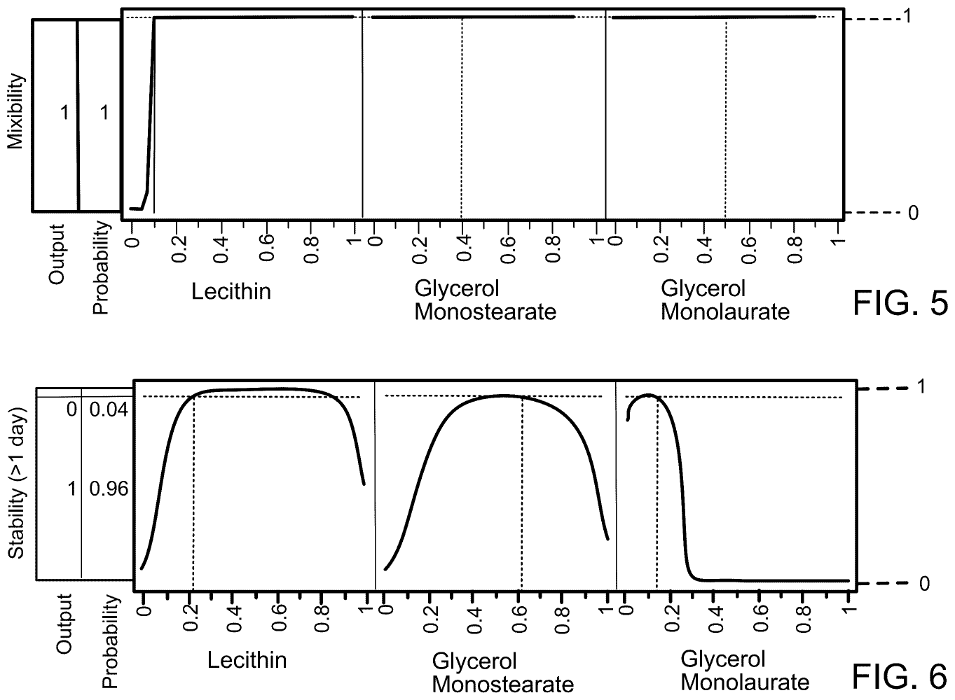

Result profiles for mixibility (1=mixable; 0=un-mixable) and stability (1=stable for >1 day; 0=stable for <1 day) of the colloidal dispersions as a function of mass fraction of lecithin, glycerol monostearate, and glycerol monolaurate are shown in FIGS. 5 and 6, respectively. The results indicated that lecithin content of greater than 10 wt % and glycerol monolaurate content of less than 15 wt % provided acceptable mixibility and stability.

### Example 3. Performance Mapping of Lecithin-Containing Compositions

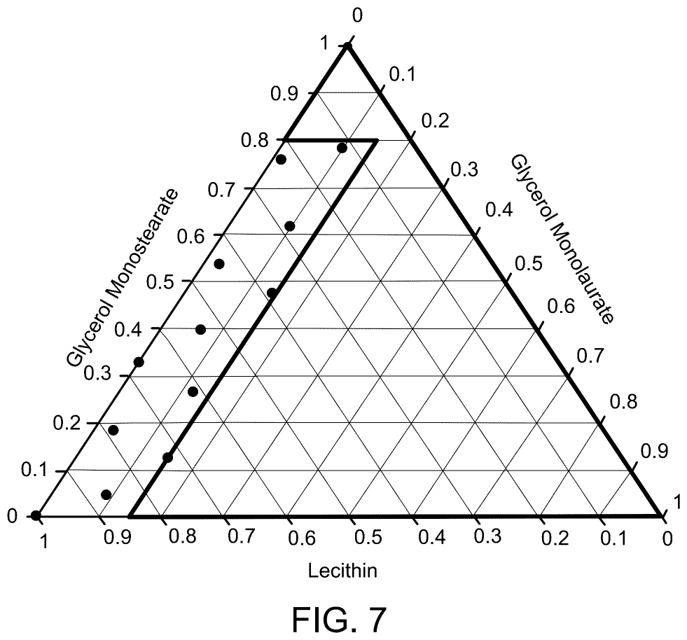

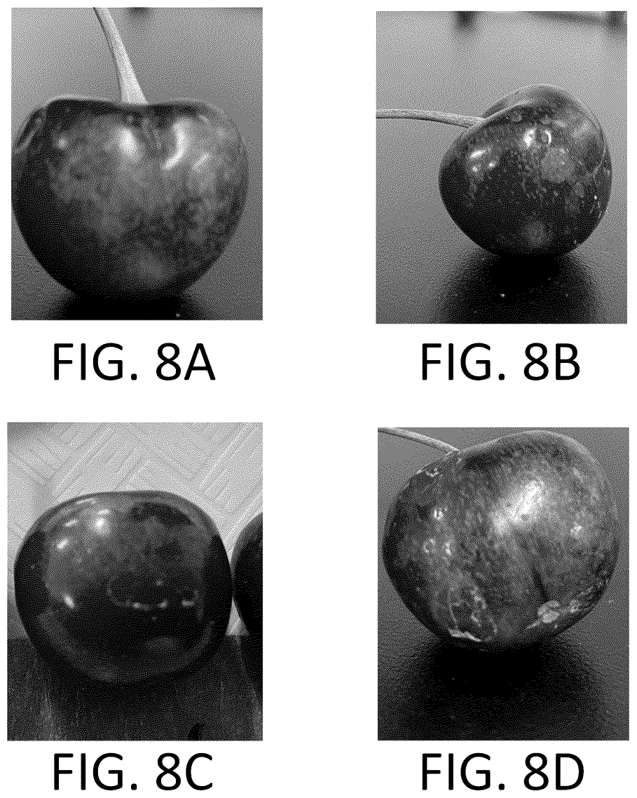

A space-filling mixture DoE was performed for coatings formed from a coating agent including combinations of sunflower lecithin (mass fraction 0-1), glyceryl monostearate (mass fraction 0-0.8), and glyceryl monolaurate (mass fraction 0-0.15) dispersed in water (50 g/L). The initial design space is shown in FIG. 7. Cherries were coated with each formulation indicated in FIG. 7 (block dots) by dipping into a bowl of the colloidal dispersion and then drying at room temperature. Coated cherries were then tested to determine mass loss factor (averaged over 100 cherries per formulation) and visually evaluated to determine a residue score (averaged over 40 cherries per formulation). Examples of coated cherries having a residue score of 0, 0.5, 1, and 2 are shown in FIGS. 8A, 8B, 8C, and 8D, respectively. A residue score of less than 0.5 was minimally noticeable or unnoticeable.

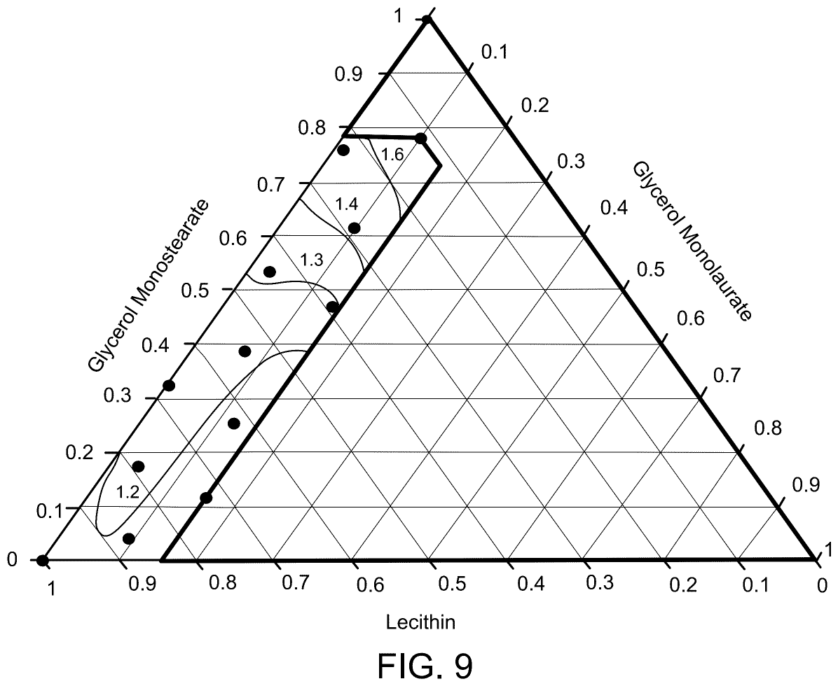

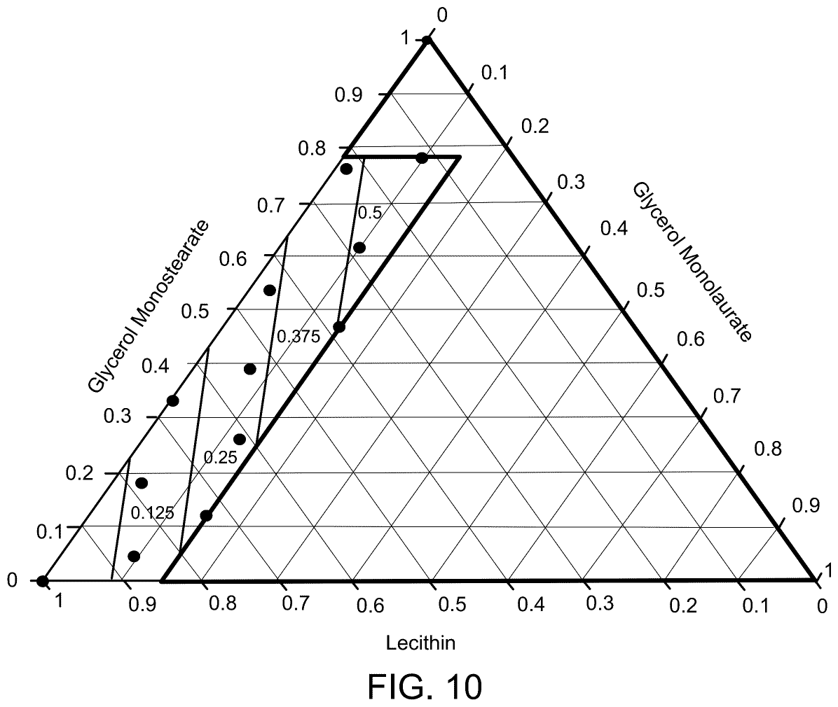

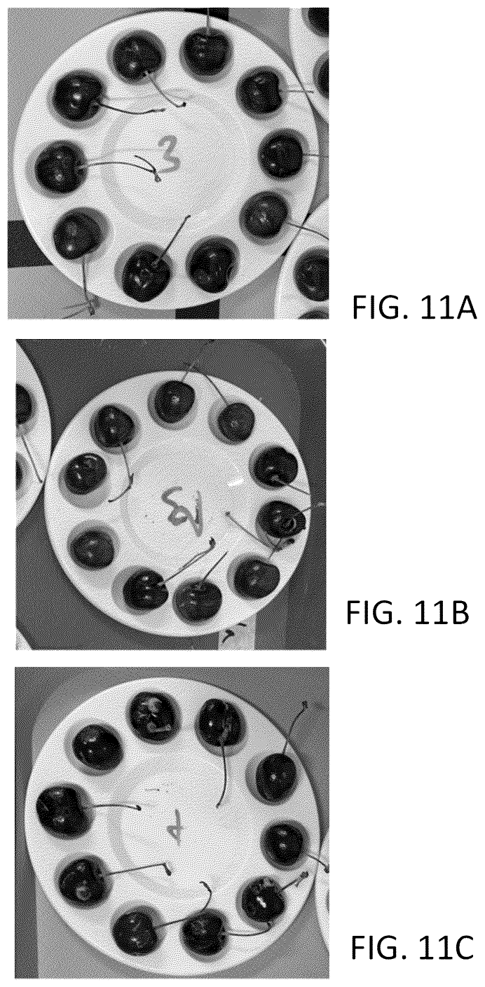

Ternary plots of mass loss factor and residue score over the design space are shown in FIGS. 9 and 10, respectively. As shown in FIG. 11, (A) a coating agent including 12.1 wt % lecithin, 78.1 wt % glycerol monostearate, and 9.8 wt % glycerol monolaurate, and (B) a coating agent including 54.1 wt % lecithin, 39.1 wt % glycerol monostearate, and 6.7 wt % glycerol monolaurate each formed coatings having an acceptable mass loss factor (1.79 and 1.33, respectively) and less visible residue as compared to that formed from (C) a comparative coating agent including 95 wt % glycerol monostearate and 5 wt % sodium stearate (mass loss factor 1.91).

### Coatings on Bananas

Coating agents F-I having the compositions shown in Table 3 were prepared.

TABLE 3
Coating Agents

| | F | G | H | I |
|---|---|---|---|---|
| Glyceryl | 96 wt % | 91 wt % | 70 wt % | 60 wt % |
| Monostearate | | | | |
| Glyceryl | — | 5 wt % | 4 wt % | — |
| Monolaurate | | | | |
| Sodium Stearate | 4 wt % | 4 wt % | — | — |
| Lecithin¹ | — | — | 26 wt % | 40 wt % |

¹sunflower lecithin (Lasenor Giralec P powder)

Mixtures 7-10 of coating agents F-H dispersed in water at the concentrations shown in Table 4 were prepared. For each of mixtures 7-10, bananas were coated by dipping into a bowl of the mixture and then drying at room temperature. Coated bananas were visually observed for delamination and residue formation.

TABLE 4
Mixtures

| | Coating Agent | Concentration |
|---|---|---|
| Mixture 7 | F | 30 g/L |
| Mixture 8 | G | 31.5 g/L |
| Mixture 9 | H | 15 g/L |
| Mixture 10 | I | 15 g/L |

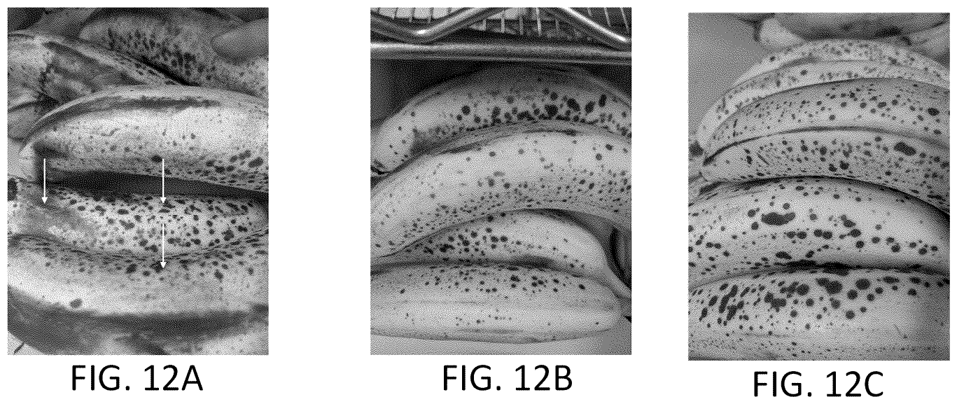

Images of bananas coated with mixtures 7, 9, and 10 are shown in FIGS. 12A, 12B, and 12C, respectively. As shown in FIGS. 12A-C, no delamination was observed for bananas coated with a lecithin-containing formulation (delamination is indicated with white arrows in FIG. 12A).

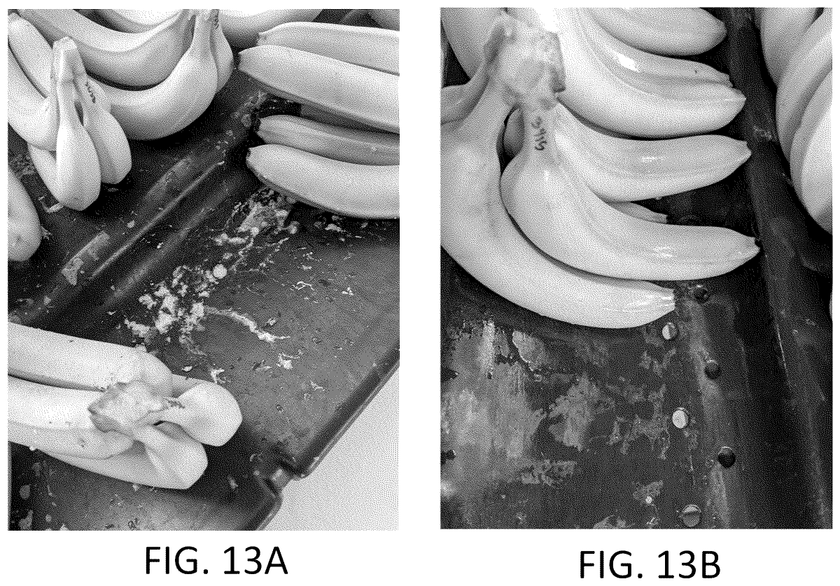

Images of bananas coated with mixtures 8 and 10 are shown in FIGS. 13A and 13B, respectively. As shown in FIGS. 13A and 13B, less residue formation was observed for coatings formed from a lecithin-containing formulation.

### Coatings on Cherry Tomatoes

Coating agents J-R having the compositions shown in Tables 5 and 6 were prepared.

TABLE 5
Coating Agents

| | J | K | L | M | N |
|---|---|---|---|---|---|
| Glyceryl | 70 wt % | 63 wt % | 49 wt % | 50 wt % | 45 wt % |
| Monostearate | | | | | |
| Glyceryl | 4 wt % | 4 wt % | 4 wt % | 5 wt % | 5 wt % |
| Monolaurate | | | | | |
| Lecithin¹ | 26 wt % | 26 wt % | 26 wt % | 45 wt % | 45 wt % |
| Ethyl | 0 wt % | 7 wt % | 21 wt % | 0 wt % | 5 wt % |
| Stearate | | | | | |

¹rapeseed lecithin (Sternchemie SternPur R P powder)

TABLE 6
Coating Agents

| | O | P | Q | R |
|---|---|---|---|---|
| Glyceryl | 35 wt % | 35 wt % | 31.5 wt % | 24.5 wt % |
| Monostearate | | | | |
| Glyceryl | 5 wt % | 5 wt % | 5 wt % | 4 wt % |
| Monolaurate | | | | |
| Lecithin¹ | 45 wt % | 60 wt % | 60 wt % | 26 wt % |
| Ethyl | 15 wt % | 0 wt % | 3.5 wt % | 10.5 wt % |
| Stearate | | | | |

¹rapeseed lecithin (Sternchemie SternPur R P powder)

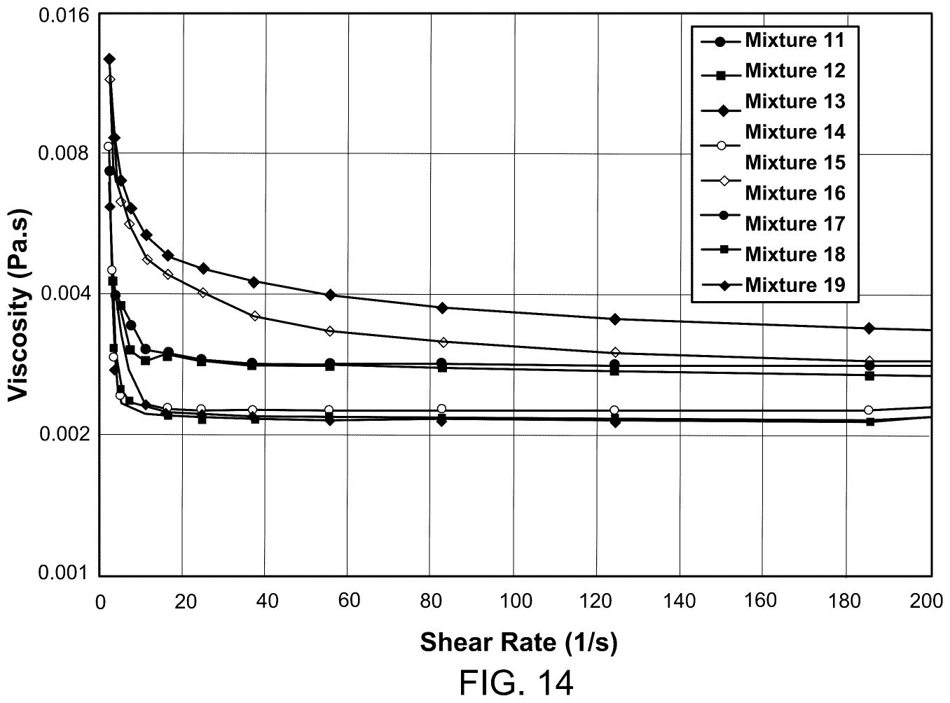

Mixtures 11-19 of coating agents J-R dispersed in water at the concentrations shown in Table 7 were prepared. Mixture 13 did not properly emulsify. Samples of each mixture were analyzed using a differential scanning calorimeter (DSC) according to the procedure of Example 1, above. The DSC results for mixtures 11-19 showed no differences in crystallinity due to the inclusion of an alkyl ester at a weight ratio of monoglyceride to alkyl ester of 9:1 to about 2:1. Viscosity of mixtures 11-19 was also determined in a rheometer (TA instruments Discovery HR-3), in a double-wall concentric cylinder (inside bob diameter 32.01 mm; outside bob diameter 35.01 mm) using a shear flow ramp method (20° C.; 0.0 soak time; 60 s duration; shear rate range 1.74-500 s⁻¹). Results, shown in FIG. 14, indicated only minimal changes to viscosity due to the inclusion of an alkyl ester at a weight ratio of monoglyceride to alkyl ester of 9:1 to about 2:1. At a weight ratio of about 2:1, mixtures were 30-40 wt % more viscous as compared to corresponding mixture lacking alkyl ester.

For each of mixtures 11-19, groups of 80 cherry tomatoes were were coated by dipping into a bowl of the mixture and then drying at room temperature. Mass loss of the coated cherry tomatoes and comparative groups of uncoated cherry tomatoes were then measured on flats.

TABLE 7
Mixtures; Mass Loss of Cherry Tomatoes

| | Coating | | Mass Loss |
|---|---|---|---|
| | Agent | Concentration | Factor¹ |
| Mixture 11 | J | 50 g/L | 1.45 |
| Mixture 12 | K | 50 g/L | 1.46 |
| Mixture 13 | L | 50 g/L | 1.27 |
| Mixture 14 | M | 30 g/L | 1.28 |
| Mixture 15 | N | 30 g/L | 1.27 |
| Mixture 16 | O | 30 g/L | 1.53 |
| Mixture 17 | P | 15 g/L | 1.17 |
| Mixture 18 | Q | 15 g/L | 1.19 |
| Mixture 19 | R | 15 g/L | 1.36 |
| Untreated | — | — | 1 |

¹ratio of the average mass loss rate of untreated control to the average mass loss rate of corresponding tested produce for a given period of time.

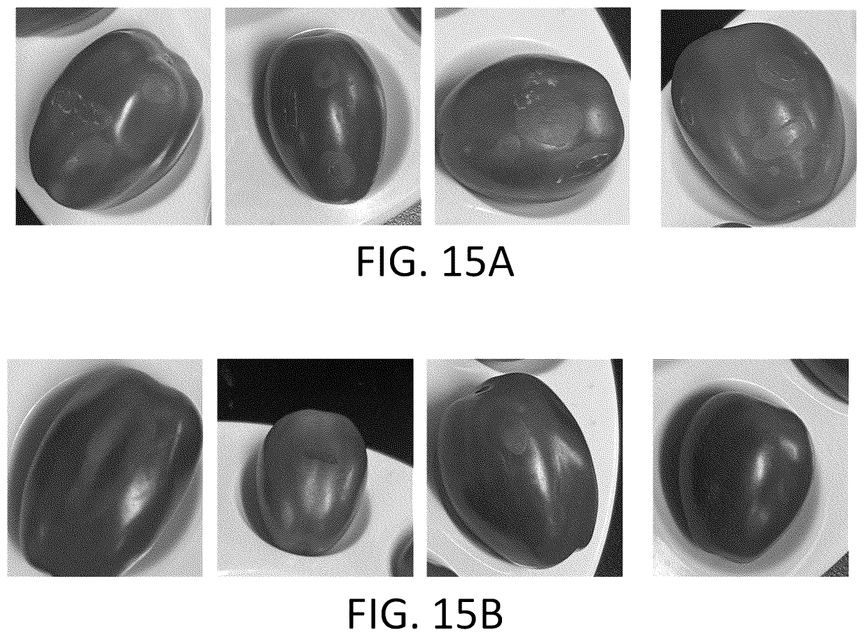

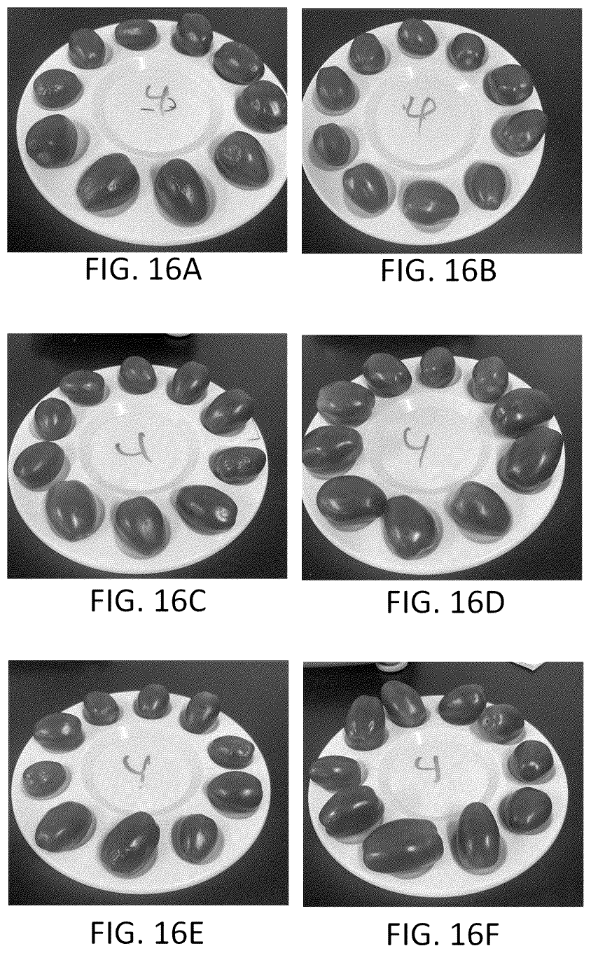

Images of cherry tomatoes one day after coating from mixtures 11 and 16 are shown in FIGS. 15A and 15B, respectively. Images of untreated cherry tomatoes and cherry tomatoes coated with mixtures 11, 14, 16, 17, and 19 after 14 days of storage at ambient temperature are shown in FIGS. 16A, 16B, 16C, 16D, 16E, and 16F, respectively. As demonstrated in Table 7, FIG. 14, FIGS. 15A and 15B, and FIGS. 16A-16F, lecithin-containing coating agents further including an alkyl ester can provide improved barrier properties without significantly affecting coating mixture properties, including residue formation.

Although this disclosure contains many specific embodiment details, these should not be construed as limitations on the scope of the subject matter or on the scope of what may be claimed, but rather as descriptions of features that may be specific to particular embodiments. Certain features that are described in this disclosure in the context of separate embodiments can also be implemented, in combination, in a single embodiment. Conversely, various features that are described in the context of a single embodiment can also be implemented in multiple embodiments, separately, or in any suitable sub-combination. Moreover, although previously described features may be described as acting in certain combinations and even initially claimed as such, one or more features from a claimed combination can, in some cases, be excised from the combination, and the claimed combination may be directed to a sub-combination or variation of a sub-combination.

Particular embodiments of the subject matter have been described. Other embodiments, alterations, and permutations of the described embodiments are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations may be considered optional), to achieve desirable results.

Accordingly, the previously described example embodiments do not define or constrain this disclosure. Other changes, substitutions, and alterations are also possible without departing from the spirit and scope of this disclosure.

1. A composition comprising:
one or more monoglycerides of a C₄-C₂₈ fatty acid, present in a total amount of about 10 wt % to about 90 wt % of the composition; and
a lecithin, present in an amount of about 10 wt % to about 90 wt % of the composition.

2. The composition of claim 1, wherein:
the one or more monoglycerides are present in a total amount of about 10 wt % to about 50 wt % of the composition;
the lecithin is present in an amount of about 50 wt % to about 90 wt % of the composition.

3. The composition of claim 1, wherein:
the one or more monoglycerides are present in a total amount of about 50 wt % to about 90 wt % of the composition; and
the lecithin is present in an amount of about 10 wt % to about 50 wt % of the composition.

4. The composition of claim 1, wherein the one or more monoglycerides comprise:
one or more monoglycerides of a C₁₆-C₂₈ fatty acid; and
one or more monoglycerides of a C₄-C₁₄ fatty acid.

5. A composition comprising:
one or more monoglycerides of a C₄-C₂₈ fatty acid;
one or more alkyl esters of a C₄-C₂₈ fatty acid; and
a lecithin;
wherein:
a ratio of a total mass of the one or more monoglycerides to a total mass of the one or more alkyl esters is about 20:1 to about 1:1; and
a ratio of a total mass of the one or more monoglycerides and the one or more alkyl esters to a total mass of the lecithin is about 10:1 to about 1:10.

6. The composition of claim 5, wherein the ratio of the total mass of the one or more monoglycerides to the total mass of the one or more alkyl esters is about 10:1 to about 2:1.

7. The composition of claim 1, wherein the lecithin comprises a hydrolyzed lecithin.

8. The composition of claim 1, wherein the lecithin comprises one or more glycerophospholipids.

9. The composition of claim 1, wherein the lecithin comprises one or more triglycerides.

10. The composition of claim 8, wherein the one or more glycerophospholipids comprise a phosphatidylcholine, a lysophosphatidylcholine, a phosphatidylethanolamine, a lysophosphatidylethanolamine, a phosphatidylinositol, a lysophosphatidylinositol, a phosphatidylserine, a lysophosphatidylserine, a phosphatidic acid, a lysophosphatidic acid, or any combination thereof.

11. The composition of claim 10, wherein the one or more glycerophospholipids comprise a phosphatidylcholine, a phosphatidylethanolamine, a phosphatidylinositol, and a phosphatidic acid.

12. The composition of claim 8, wherein one or more of the glycerophospholipids independently comprises a compound of Formula III: 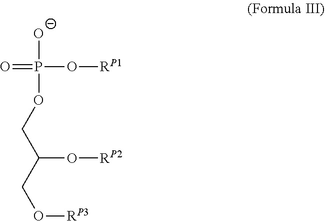
wherein:
each R^{P1} is independently —H, 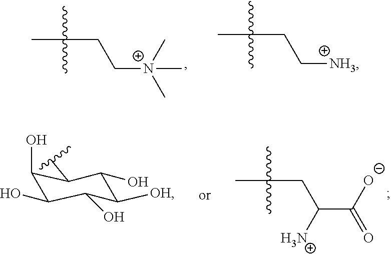
each R^{P2} and R^{P3} are independently —H or —C(O)R^{H};
at least one of R^{P2} and R^{P3} is not —H; and
each R^{H} is independently a C₇-C₂₁ side chain.

13. The composition of claim 9, wherein one or more of the triglycerides independently comprises a compound of Formula IV: 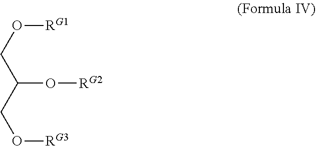
wherein:
each R^{G1}, R^{G2}, and R^{G3} are independently −C(O)R^{H}; and
each R^{H} is independently a C₇-C₂₁ side chain.

14. The composition of claim 1, wherein each of the one or more monoglycerides independently comprises a compound of Formula I-i or Formula I-ii: 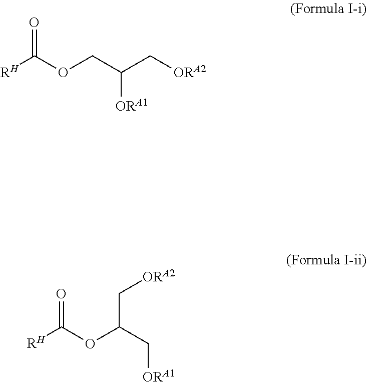
wherein:
R^{A1} and R^{A2} are each independently selected from H and C₁-C₆ alkyl; and
R^{H} is a C₃-C₂₇ side chain.

15. The composition of claim 5, wherein each of the one or more alkyl esters independently comprises a compound of Formula V: 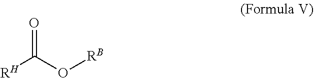
wherein:
R^{B} is C₁-C₈ alkyl; and
R^{H} is a C₇-C₁₉ side chain.

16. A mixture comprising:
the composition of claim 1; and
a solvent.

17. A coated agricultural product comprising an agricultural product and a layer disposed on a surface of the agricultural product, wherein the layer comprises the composition of claim 1.

18. A method of coating an agricultural product, the method comprising:
contacting a surface of the agricultural product with a mixture comprising a coating agent and a solvent, wherein the coating agent comprises:
one or more monoglycerides of a C₄-C₂₈ fatty acid; and
a lecithin,
wherein a ratio of a total mass of the one or more monoglycerides to a total mass of the lecithin is about 10:1 to about 1:10; and
removing at least a portion of the solvent to form a coating on the surface of the agricultural product.

19. The method of claim 18, wherein the one or more monoglycerides comprise:
one or more monoglycerides of a C₁₆-C₂₈ fatty acid; and
one or more monoglycerides of a C₄-C₁₄ fatty acid.

20. The method of claim 18, wherein removing at least a portion of the solvent comprises evaporating at least a portion of the solvent at a temperature of less than 40° C.
